(19) United States
(12) Patent Application Publication
(10) Pub. No.: US 2026/0336080 A1
(43) Pub. Date: Oct. 29, 2026

(54) WORKING MACHINE

(71) Applicant: Koki Holdings Co., Ltd., Tokyo (JP)

(72) Inventors: Shota SUZUKI, Ibaraki (JP); Toshinori YASUTOMI, Ibaraki (JP); Tatsuya ITO, Ibaraki (JP)

(21) Appl. No.: 19/124,241

(22) PCT Filed: Oct. 24, 2023
(86) PCT No.: PCT/JP2023/038343

§ 371 Date: Apr. 24, 2025

(30) Foreign Application Priority Data
Oct. 25, 2022 (JP) 2022-170376
Apr. 28, 2023 (JP) 2023-074260

(51) Int. Cl. B25C 1/06; B25C 5/15

(52) U.S. Cl. CPC B25C 1/06; B25C 5/15

(57) ABSTRACT

A driver includes a striking portion, a pin wheel that rotates by a driving force of an electric motor, and a control unit that controls the electric motor. The pin wheel has a plurality of rotating portion-side engagement portions, and the striking portion has a plurality of striking portion-side engagement portions. The striking portion moves upward when the pin wheel rotates in an engaged state where the rotating portion-side engagement portion and the striking portion-side engagement portion is engaged with each other. The control unit determines whether or not the plurality of striking portion-side engagement portions and the plurality of rotating portion-side engagement portions have a predetermined engagement relationship in a striking operation.

### CROSS-REFERENCE TO RELATED APPLICATIONS

This application is the U.S. National Phase under 35 U.S.C. § 371 of International Application No. PCT/JP 2023/038343, filed on Oct. 24, 2023, which claims the benefit of foreign priority to Japanese Patent Application No. 2022-170376 filed on Oct. 25, 2022 and Japanese Patent Application No. 2023-074260 filed on Apr. 28, 2023, the entire contents of each of which are hereby incorporated by reference.

### TECHNICAL FIELD

The present invention relates to a working machine such as a driver.

### BACKGROUND ART

As an example of a working machine, a driver including a driver blade that strikes a fastener, a pin wheel that pushes up the driver blade, and a motor that rotates the pin wheel is known.

As the driver as described above, for example, Patent Document 1 discloses a driver including a mechanism in which a pin of a pin wheel is engaged with a rack provided on a driver blade, a fastener is driven by the driver blade, and then the driver blade is pushed up by rotation of the pin wheel.

### RELATED ART DOCUMENT

### Patent Document

Patent Document 1: WO 2018/180082 A

### SUMMARY OF THE INVENTION

### Problems to be Solved by the Invention

In the driver disclosed in Patent Document 1 described above, the number of pins and the same number of racks are provided to correspond to each other, and the pin wheel rotates in a state where the pins and the racks are engaged with each other, whereby the driver blade is pushed upward.

In such a driver, in a case where a nail (fastener) is jammed at an injection port or in a case where the rebound of the driver blade from the mating material (driven material) due to the hardness of the mating material is large, the stop position of the driver blade after driving is different from the position at a normal time. As a result, when the driver blade is pushed up by the pin wheel, there is a concern that a misalignment will occur between the pin and the rack.

When misalignment occurs in the engagement between the pin and the rack, there is a concern that the driver blade collides with the last pin in a rotation direction of the pin wheel during driving, and the pin will become damaged. When the pin is damaged, part replacement and the like is required, and the convenience of the driver may be impaired.

An object of the present invention is to provide a working machine with improved convenience.

### Means for Solving the Problems

A working machine of the present invention includes a motor, a striking portion capable of striking a fastener by moving to one side in a first direction, a biasing portion that biases the striking portion to the one side in the first direction, a rotating portion that rotates by a driving force of the motor and is engageable with and disengageable from the striking portion, and a control unit that controls driving of the motor, in which the rotating portion includes a plurality of rotating portion-side engagement portions provided along a rotation direction of the rotating portion, and the striking portion includes a plurality of striking portion-side engagement portions that is provided along the first direction and is engageable with the plurality of rotating portion-side engagement portions, the striking portion moves to another side in the first direction when the rotating portion rotates in a state where the plurality of striking portion-side engagement portions is engaged with the plurality of rotating portion-side engagement portions, and when the engagement with the rotating portion is released, a striking operation in which the striking portion moves to the one side in the first direction due to a biasing force of the biasing portion, thereby striking the fastener is executed, and the control unit determines whether or not the plurality of striking portion-side engagement portions and the plurality of rotating portion-side engagement portions have a predetermined engagement relationship in the striking operation.

Another working machine of the present invention includes a motor, a striking portion capable of striking a fastener by moving to one side in a first direction, a biasing portion that biases the striking portion to the one side in the first direction, a rotating portion that rotates by a driving force of the motor and is engageable with and disengageable from the striking portion, and a control unit that controls driving of the motor, in which the rotating portion includes a plurality of rotating portion-side engagement portions provided along a rotation direction of the rotating portion, and the striking portion includes a plurality of striking portion-side engagement portions that is provided along the first direction and is engageable with the plurality of rotating portion-side engagement portions, the striking portion moves to another side in the first direction when the rotating portion rotates in a state where the plurality of striking portion-side engagement portions is engaged with the plurality of rotating portion-side engagement portions, and when the engagement with the rotating portion is released, a striking operation in which the striking portion moves to the one side in the first direction due to a biasing force of the biasing portion, thereby striking the fastener is executed, the striking portion includes a plurality of intermediate portions provided between the plurality of striking portion-side engagement portions, and any of the plurality of intermediate portions includes a deformation intermediate portion having a shape different from a shape of the other intermediate portion. Still another working machine of the present invention includes a motor, a striking portion capable of striking a fastener by moving to one side in a first direction, a biasing portion that biases the striking portion to the one side in the first direction, a rotating portion that rotates by a driving force of the motor and is engageable with and disengageable from the striking portion, and a control unit that controls driving of the motor, in which the rotating portion includes a plurality of rotating portion-side engagement portions provided along a rotation direction of the rotating portion, and the striking portion includes a plurality of striking portion-side engagement portions that is provided along the first direction and is engageable with the plurality of rotating portion-side engagement portions, the striking portion moves to another side in the first direction when the rotating portion rotates in a state where the plurality of striking portion-side engagement portions is engaged with the plurality of rotating portion-side engagement portions, and when the engagement with the rotating portion is released, a striking operation in which the striking portion moves to the one side in the first direction due to a biasing force of the biasing portion, thereby striking the fastener is executed, the control unit includes a learned model that estimates a state of engagement between the plurality of striking portion-side engagement portions and the plurality of rotating portion-side engagement portions based on a change in current value of the motor or a change in rotation speed of the motor, and an computing unit that controls driving of the motor in accordance with the state of the engagement between the plurality of striking portion-side engagement portions and the plurality of rotating portion-side engagement portions, which is estimated by the learned model.

### Effects of the Invention

According to the present invention, it is possible to improve the convenience of the working machine.

### BRIEF DESCRIPTIONS OF THE DRAWINGS

FIG. 1 is a perspective view illustrating an appearance structure of a working machine according to a first embodiment of the present invention.

FIG. 2 is a side view illustrating a structure of the working machine illustrated in FIG. 1.

FIG. 3 is a cross-sectional view illustrating a structure taken along line A-A in FIG. 2.

FIG. 4 is a block diagram of a control system of the working machine illustrated in FIG. 1.

FIGS. 5A and 5B are views illustrating a structure of a striking portion assembled to the working machine illustrated in FIG. 1, in which FIG. 5A is a front view and FIG. 5B is a side view.

FIG. 6 is a time series diagram illustrating a state of a blade detector switch and a Hall IC count in a normal sequence related to an engagement state of a rack and a pin of the working machine in FIG. 1.

FIGS. 7A, 7B, and 7C are conceptual diagrams illustrating engagement states of the rack and the pin corresponding to a time point T1, a time point T2, and a time point T3 in the normal sequence of FIG. 6.

FIGS. 8A and 8B are conceptual diagrams illustrating engagement states of the rack and the pin corresponding to a time point T4 and a time point T5 in the normal sequence of FIG. 6.

FIGS. 9A and 9B are conceptual diagrams illustrating engagement states of the rack and the pin corresponding to a time point T6 and a time point T7 in the normal sequence of FIG. 6.

FIG. 10 is a time series diagram illustrating the state of the blade detector switch and the Hall IC count in a misalignment sequence related to the engagement state of the rack and the pin of the working machine in FIG. 1.

FIGS. 11A, 11B, and 11C are conceptual diagrams illustrating engagement states of the rack and the pin corresponding to a time point U1, a time point U2, and a time point U3 in the misalignment sequence of FIG. 10.

FIGS. 12A and 12B are conceptual diagrams illustrating engagement states of the rack and the pin corresponding to a time point U4 and a time point U5 in the misalignment sequence of FIG. 10.

FIGS. 13A and 13B are conceptual diagrams illustrating engagement states of the rack and the pin corresponding to a time point U6 and a time point U7 in the misalignment sequence of FIG. 10.

FIGS. 14A and 14B are conceptual diagrams illustrating engagement states of the rack and the pin corresponding to a time point U8 and a time point U9 in the misalignment sequence of FIG. 10.

FIG. 15 is a flowchart of misalignment detection control in motor control of the working machine in FIG. 1.

FIG. 16 is a flowchart of misalignment release control in the motor control of the working machine in FIG. 1.

FIG. 17 is a flowchart of an operation in a misalignment mode in the misalignment detection control of FIG. 15.

FIG. 18 is a side sectional view illustrating an internal structure of a working machine according to a second embodiment of the present invention.

FIG. 19 is a circuit block diagram of the working machine in the second embodiment.

FIG. 20 is a block diagram of a control unit of the working machine according to the second embodiment.

FIGS. 21A and 21B are views illustrating an engagement state between a rack and a pin of the working machine according to the second embodiment, in which FIG. 21A is a side view illustrating the engagement state between the rack and the pin, and FIG. 21B is a partially enlarged view illustrating shapes of a plurality of racks.

FIG. 22 is a flowchart of misalignment determination control in the working machine of the second embodiment.

FIG. 23 is a graph illustrating the relationship between a time of one driving cycle and a battery current value in the working machine of the second embodiment.

FIG. 24 is a graph illustrating a relationship between the time and the battery current value in normal lift-up/abnormal lift-up at start of lift-up in the engaged state between the rack and the pin illustrated in FIG. 4.

FIGS. 25A and 25B are views illustrating an engagement state between a rack and a pin of a working machine according to a modification example of the second embodiment, in which FIG. 25A is a side view illustrating the engagement state between the rack and the pin, and FIG. 25B is a partially enlarged view illustrating shapes of a plurality of racks.

FIG. 26 is a graph illustrating a relationship between a time and a battery current value in normal lift-up/abnormal lift-up at start of lift-up of the working machine according to the modification example of the second embodiment.

FIG. 27 is a block diagram of a control unit of a working machine according to a third embodiment.

FIG. 28 is a side view illustrating an engagement state between a rack and a pin of the working machine according to the third embodiment.

FIG. 29 is a flowchart of misalignment determination control in the working machine of the third embodiment.

FIG. 30 is a graph illustrating a relationship between a time and a battery current value in normal lift-up/abnormal lift-up at start of lift-up of the working machine according to the third embodiment.

FIG. 31 is a graph illustrating a relationship between the time and a rotation speed of a motor in the normal lift-up/abnormal lift-up at the start of lift-up of the working machine according to the third embodiment.

FIG. 32 is a network configuration diagram illustrating a structure of a neural network in normal lift-up of the working machine according to the third embodiment.

### DETAILED DESCRIPTION OF PREFERRED EMBODIMENTS

A typical embodiment of a driver of the present invention will be described with reference to the drawings.

### First Embodiment

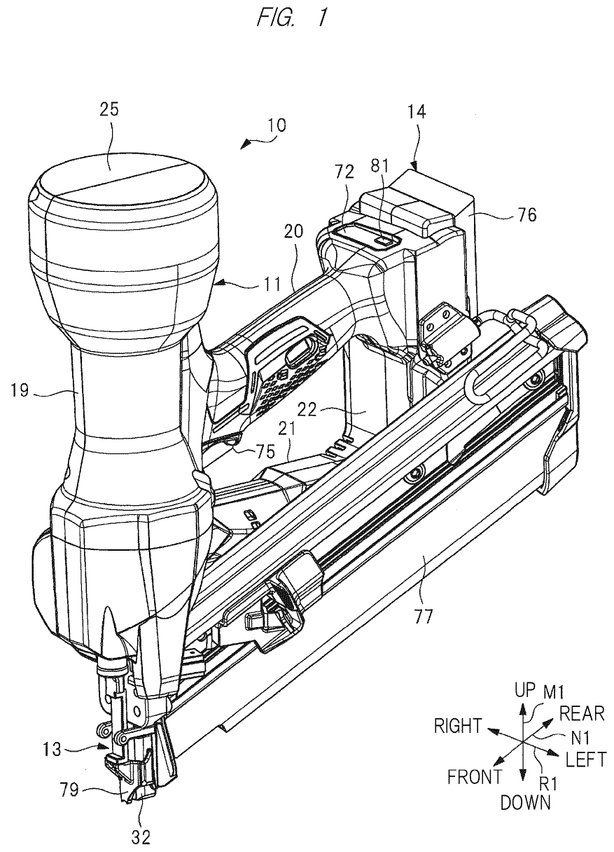

A driver (working machine) 10 illustrated in FIGS. 1 to 4 is an air compression type working machine, and includes a housing 11, a striking portion 12, a nose portion 13, a power source unit 14, an electric motor (motor) 15, a winding-up mechanism 17, and a pressure accumulation container 18. The housing 11 is an outer shell element of the driver 10, and includes a cylinder case 19, a handle 20, a motor case 21, and a mounting portion 22. The cylinder case 19 has a tubular shape, and the handle 20 and the motor case 21 are connected to the cylinder case 19. In addition, the mounting portion 22 is connected to the handle 20 and the motor case 21.

The power source unit 14 can be attached to and detached from the mounting portion 22. The electric motor 15 is disposed in the motor case 21. The cylinder case 19 is provided with a head cover 25, and the pressure accumulation container 18 is disposed over the inside of the cylinder case 19 and the inside of the head cover 25.

Furthermore, a cylinder 27 is accommodated in the cylinder case 19, and the pressure accumulation container 18 includes a cap 23 and a holder 24 attached to the cylinder 27. The cylinder 27 is made of metal, for example, aluminum or iron. The cylinder 27 is positioned in a direction along a center line Al with respect to the cylinder case 19 and a radial direction. The center line Al passes through the center of the cylinder 27. The radial direction is a radial direction of a virtual circle centered on the center line A1. In addition, a pressure chamber 26 is formed over the inside of the pressure accumulation container 18 and the inside of the cylinder 27. The pressure chamber 26 is filled with a compressed gas. As the compressed gas, an inert gas can be used in addition to air. The inert gas includes, for example, a nitrogen gas and a rare gas. In a present first embodiment, an example in which the pressure chamber 26 is filled with air will be described. Note that the pressure chamber 26 is also a biasing portion that biases the striking portion 12 downward (toward one side) in an up-down direction (first direction) M1.

The striking portion 12 is disposed from the inside to the outside of the housing 11. The striking portion 12 includes a piston 28 and a driver blade 29. The piston 28 is operable in the cylinder 27 in the direction along the center line Al. An annular seal member 84 is attached to an outer peripheral surface of the piston 28. The seal member 84 is in contact with the inner peripheral surface of the cylinder 27 to form a seal surface. The driver blade 29 is made of, for example, metal, non-ferrous metal, or steel. The piston 28 and the driver blade 29 are provided as separate members, and the piston 28 and the driver blade 29 are joined.

As a result, the striking portion 12 can strike a nail (fastener) 78 by moving downward (toward one side) in the up-down direction (first direction) M1.

The nose portion 13 is disposed over the inside and the outside of the cylinder case 19. The nose portion 13 includes a bumper support portion 31, an injection portion 32, and a columnar portion 33. The bumper support portion 31 has a cylindrical shape. In addition, a bumper 35 is disposed in the bumper support portion 31. The bumper 35 may be made of either synthetic rubber or silicone rubber. The bumper 35 has a guide hole 36. The center line A1 passes through the guide hole 36. The driver blade 29 is disposed in the guide hole of the bumper support portion 31 and in the guide hole 36. The striking portion 12 can operate in a driving direction D1 and a return direction D2 along the center line A1. The driving direction D1 and the return direction D2 are opposite to each other. The driving direction D1 is a direction in which the piston 28 approaches the bumper 35. The return direction D2 is a direction in which the piston 28 separate from the bumper 35. The striking portion 12 is constantly biased in the driving direction D1 by the gas pressure of the pressure chamber 26. The operation of the striking portion 12 in the driving direction D1 can be defined as lowering. The operation of the striking portion 12 in the return direction D2 can be defined as rising. The driving direction D1 is the same as the downward (one) side in the up-down direction (first direction) M1. The return direction D2 is the same as the upward (other) side in the up-down direction (first direction) M1.

The injection portion 32 is connected to the bumper support portion 31 and protrudes from the bumper support portion 31 in the direction along the center line A1. The injection portion 32 has an injection path 37, and the injection path 37 is provided along the center line A1. The driver blade 29 can be operated in the direction along the center line A1 in the injection path 37.

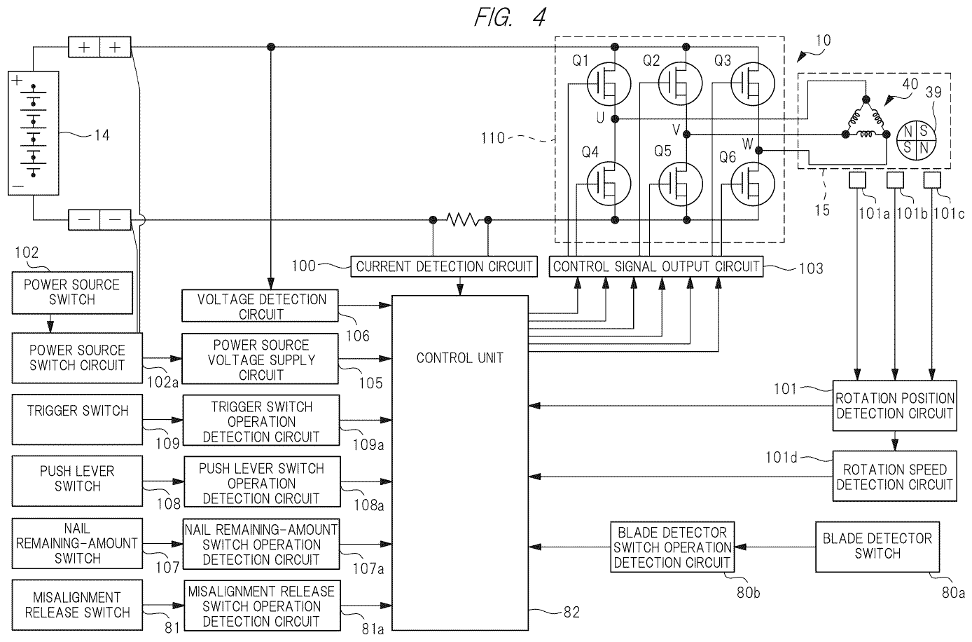

The electric motor 15 is disposed in the motor case 21. The electric motor 15 includes a rotor 39 and a stator 40 illustrated in FIG. 4. The stator 40 is attached to the motor case 21. The rotor 39 is rotatably supported by the motor case 21 via a bearing (not illustrated). The electric motor 15 is, for example, a brushless motor, and when a voltage is applied to the electric motor 15, the rotor 39 rotates about a center line A2.

Furthermore, a speed reduction mechanism (not illustrated) is provided in the motor case 21. The speed reduction mechanism includes a plurality of sets of planetary gear mechanisms. Note that a rotation shaft 46 is provided in the columnar portion 33. The rotation shaft 46 and the speed reduction mechanism are concentrically disposed about the center line A2. The speed reduction mechanism is disposed in a power transmission path from the electric motor 15 to the rotation shaft 46, and is a mechanism that decelerates the rotation of the rotor 39 of the electric motor 15 and transmits the rotation to the winding-up mechanism 17. The winding-up mechanism 17 is a mechanism that converts the rotational force of the rotation shaft 46 into a force that biases the striking portion 12 in the return direction D2.

In addition, the driver 10 is provided with a trigger 75 and a trigger switch 109 (see FIG. 4). The trigger 75 and the trigger switch 109 are provided on the handle 20. The trigger switch 109 detects the presence or absence of the operational force applied to the trigger 75 and outputs a signal corresponding to the detection result.

The power source unit 14 includes an accommodation case 76 and a battery accommodated in the accommodation case 76. The battery includes a plurality of battery cells. These battery cells are secondary batteries that can be charged and discharged, and as the battery cells, known battery cells such as a lithium ion battery, a nickel hydrogen battery, a lithium ion polymer battery, and a nickel cadmium battery can be freely used.

In addition, the driver 10 is provided with a magazine 77. The magazine 77 is supported by the injection portion 32 and the mounting portion 22. A nail (fastener) 78 is accommodated in the magazine 77. The magazine 77 has a feeder, and the feeder feeds the nail 78 in the magazine 77 to the injection path 37. That is, the feeder moves the nail 78 in the magazine 77 to the front side in the front-rear direction N1. Note that the injection portion 32 is made of metal or synthetic resin. A push lever 79 is attached to the injection portion 32. The push lever 79 can be operated within a predetermined range in the direction along the center line A1 with respect to the injection portion 32. An elastic member (not illustrated) that biases the push lever 79 in the direction along the center line Al is provided. The elastic member is, for example, a metal spring, and biases the push lever 79 in a direction away from the bumper support portion 31.

Next, the control unit 82 that is provided in the driver 10 and is illustrated in FIG. 4 will be described. The control unit 82 is provided in the mounting portion 22, and mainly controls driving of the electric motor 15. Furthermore, an inverter circuit 110 illustrated in FIG. 4 is connected to the control unit 82. The inverter circuit 110 connects and disconnects the stator 40 of the electric motor 15 and the power source unit 14. The inverter circuit 110 includes a plurality of switching elements Q1, Q2, Q3, 04, 05, and 06, and the plurality of switching elements Q1, Q2, Q3, Q4, Q5, and Q6 can be turned on and off, respectively. The control unit 82 controls the inverter circuit 110 via a control signal output circuit 103 to control the rotation and stop of the electric motor 15, or the rotation speed of the electric motor 15 and the rotation direction of the electric motor 15.

In addition, the driver 10 includes, as input elements that transmit signals to the control unit 82, a blade detector switch (first switch, and also referred to as a BDSW) 80a that detects the position of the driver blade 29, a current detection circuit 100, a rotation position detection circuit 101 of the rotor 39, a power source switch 102, and a power source switch circuit 102a. The blade detector switch 80a is connected to the control unit 82 via a blade detector switch operation detection circuit 80b, the rotation position detection circuit 101 is connected to the control unit 82 via a rotation speed detection circuit 101d, and the power source switch circuit 102a is connected to the control unit 82 via a power source voltage supply circuit 105.

Furthermore, as other input elements that transmit signals to the control unit 82, there are provided a misalignment release switch (second switch) 81 that releases misalignment in engagement between the driver blade 29 and a pin wheel (rotating portion) 50 which will be described later, a nail remaining-amount switch 107 that detects the remaining amount of the nail 78, a voltage detection circuit 106, a push lever switch 108, and a trigger switch 109. The misalignment release switch 81 is connected to the control unit 82 via a misalignment release switch operation detection circuit 81a. As illustrated in FIG. 1, the misalignment release switch 81 is installed in an operation unit 72 provided in the mounting portion 22 of the housing 11 of the driver 10. The nail remaining-amount switch 107 is connected to the control unit 82 via a nail remaining-amount switch operation detection circuit 107a. The push lever switch 108 is connected to the control unit 82 via a push lever switch operation detection circuit 108a, and the trigger switch 109 is connected to the control unit 82 via a trigger switch operation detection circuit 109a.

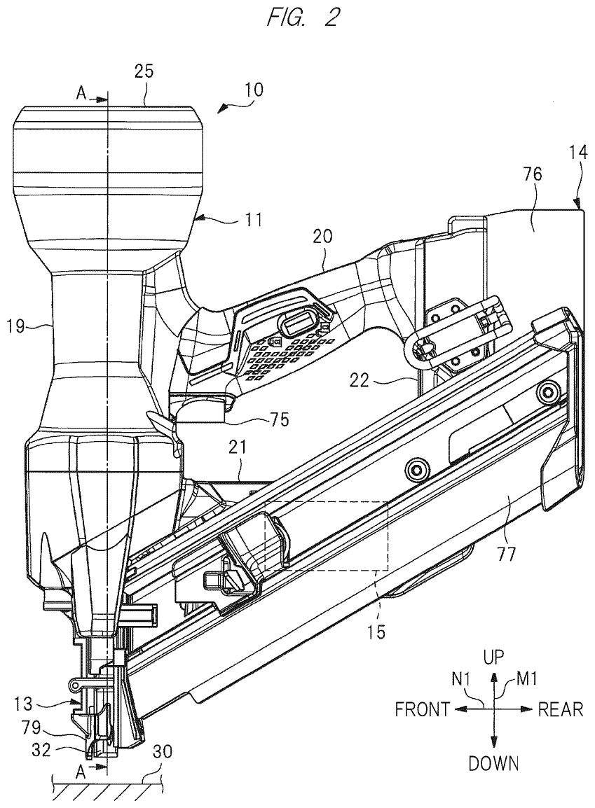

Note that the push lever 79 illustrated in FIG. 2 can be switched between ON and OFF by being pressed against the mating material 30 by an operator, and the push lever switch 108 is turned ON and outputs a signal by pressing the push lever 79 against the mating material 30, for example. In addition, the trigger switch 109 outputs a signal when the trigger switch 109 is turned ON by the operator operating the trigger 75 provided on the handle 20. The rotation position detection circuit 101 detects the position of the rotor 39 in the rotation direction by rotation position detection elements (rotation position detection units) 101a, 101b, and 101c, which are Hall ICs, and outputs a signal.

Then, the control unit 82 processes the respective signals transmitted from the rotation position detection circuit 101, the blade detector switch 80a, the push lever switch 108, the trigger switch 109, and the like, and controls the inverter circuit 110. As described above, the control unit 82 controls the stop, rotation, rotation direction, and rotation speed of the electric motor 15.

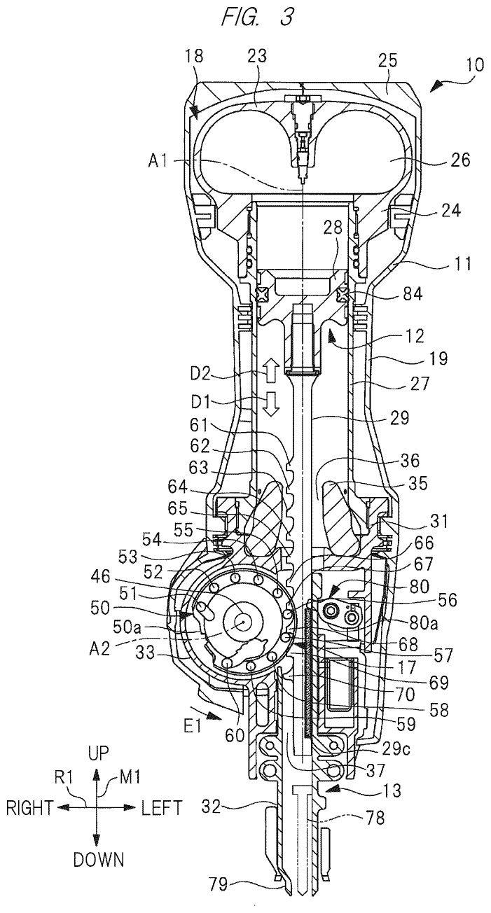

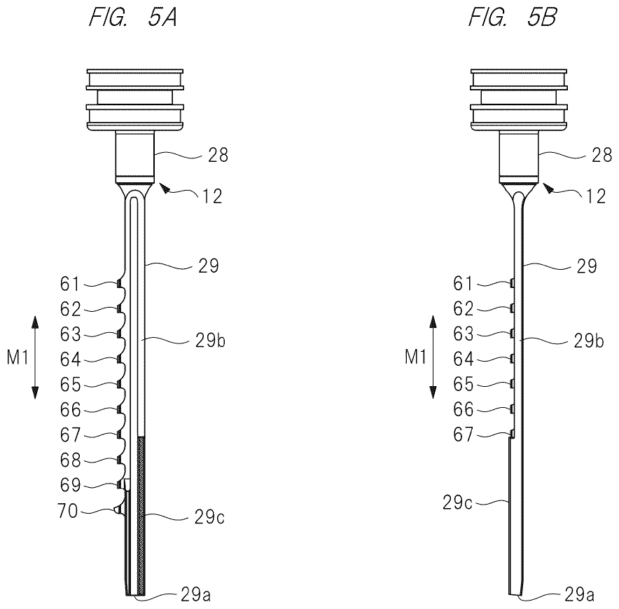

Next, the winding-up mechanism 17 provided in the driver 10 will be described. As illustrated in FIG. 3, the winding-up mechanism 17 includes the driver blade 29, a plurality of striking portion-side engagement portions provided on the driver blade 29, a pin wheel (rotating portion) 50, and a plurality of rotating portion-side engagement portions provided on the pin wheel 50. The plurality of striking portion-side engagement portions and the plurality of rotating portion-side engagement portions can be engaged with each other. In a plane perpendicular to the center line A1, the cross-sectional shape of the driver blade 29 is substantially quadrangular. As illustrated in FIGS. 5A and 5B, the driver blade 29 is provided with racks 61, 62, 63, 64, 65, 66, 67, 68, 69, and 70 as a plurality of striking portion-side engagement portions. These racks 61, 62, 63, 64, 65, 66, 67, 68, 69, and 70 are provided integrally with the driver blade 29. Further, the racks 61, 62, 63, 64, 65, 66, 67, 68, 69, and 70 are disposed between a distal end 29a of the driver blade 29 in the direction along the center line A1 and the piston 28. Further, the racks 61, 62, 63, 64, 65, 66, 67, 68, 69, and 70 are provided along the up-down direction M1, and are arranged in this order in the direction along the center line A1. In the driver 10 of the present first embodiment, the racks 61, 62, 63, 64, 65, 66, 67, 68, 69, and 70 are protrusions provided at the edge of the driver blade 29.

When the striking portion 12 operates in the return direction D2 illustrated in FIG. 3, the rack 61 among the plurality of racks is located at the head, that is, the first in the return direction D2. When the striking portion 12 operates in the return direction D2, the racks 62, 63, 64, 65, 66, 67, 68, 69, and 70 are located behind the rack 61.

As illustrated in FIG. 5, the driver blade 29 is provided with a rib 29c on a side surface of a blade body 29b. The rib 29c is provided at the blade body 29b along the up-down direction M1 of the driver blade 29. The rib 29c is provided to a predetermined height upward from the distal end 29a of the blade body 29b, and protrudes in a direction forming 90° with the protruding direction of each rack. The rib 29c is provided to be engageable with the blade detector switch 80a provided in the nose portion 13 illustrated in FIG. 3. Specifically, the driver blade 29 and the blade detector switch 80a have a positional relationship in which the driver blade 29 and the blade detector switch 80a are engaged with each other within a predetermined range in the movement of the driver blade 29 in the up-down direction M1.

As a result, the control unit 82 detects the position of the striking portion 12 including the driver blade 29 in the direction of the center line Al by processing an on/off signal of the blade detector switch 80a due to the engagement between the rib 29c of the driver blade 29 and the blade detector switch 80a.

On the other hand, as illustrated in FIG. 3, the pin wheel 50 is attached to the rotation shaft 46. The pin wheel 50 is a rotating portion that rotates by the driving force of the electric motor 15. The pin wheel 50 can be engaged with the striking portion 12 and can be disengaged from the striking portion 12. For example, the pin wheel 50 is made of metal, non-ferrous metal, or steel. The pin wheel 50 rotates about the center line A2. The center line A2 is disposed apart from the driver blade 29 in the right-left direction R1 in a direction intersecting an operation direction of the striking portion 12.

The pin wheel 50 has a plurality of rotating portion-side engagement portions provided along the rotation direction E1. As an example of the plurality of rotating portion-side engagement portions, 10 pins 51, 52, 53, 54, 55, 56, 57, 58, 59, and 60 are provided at the pin wheel 50. The pins 51, 52, 53, 54, 55, 56, 57, 58, 59, and 60 are provided separately from the pin wheel 50, and are fixed to protrude from the disk surface of the pin wheel 50. Further, the pins 51, 52, 53, 54, 55, 56, 57, 58, 59, and 60 are arranged on the same circumference centered on the center line A2.

In addition, in the pin wheel 50, a cutout portion 50a is formed in a second region at a predetermined angle in the rotation direction E1 of the pin wheel 50. The cutout portion 50a is formed in a region of 90° as an example. The minimum outer diameter of the cutout portion 50a centered on the center line A2 is smaller than the maximum outer diameter of a first region where the cutout portion 50a is not formed. The first region where the cutout portion 50a is not formed is a region of approximately 270° in the rotation direction El of the pin wheel 50.

Note that the pins 51, 52, 53, 54, 55, 56, 57, 58, 59, and 60 of the pin wheel 50 and the racks 61, 62, 63, 64, 65, 66, 67, 68, 69, and 70 of the driver blade 29 are provided at overlapping positions in the direction along the center line A2, and have a positional relationship of engaging with each other.

In addition, the pin wheel 50 rotates counterclockwise in FIG. 3 by the rotational force of the electric motor 15. In the pin wheel 50 of the present first embodiment, as an example, the pin 51 is disposed in the second region in the rotation direction E1 of the pin wheel 50, and the pins 52, 53, 54, 55, 56, 57, 58, 59, and 60 are disposed in the first region in the rotation direction E1 of the pin wheel 50. The pins 52, 53, 54, 55, 56, 57, 58, 59, and 60 are arranged in this order along the rotation direction E1 of the pin wheel 50. The pin 51 is located at the head, that is, at the first position in the rotation direction E1 during one rotation of the pin wheel 50.

In addition, the pins 52, 53, 54, 55, 56, 57, 58, 59, and 60 are located behind the pin 51 in the rotation direction E1 of the pin wheel 50. Therefore, when the pin wheel 50 rotates in a state where the striking portion 12 is stopped, the pin 51 of the plurality of pins first approaches an operational region of the driver blade 29 in the rotation direction E1 of the pin wheel 50.

Note that, in the driver 10, the rotation position that is the position of the pin wheel 50 in the rotation direction E1 is detected by the rotation position detection elements (rotation position detection units) 101a, 101b, and 101c that are Hall ICs that detect the position of the rotor 39 in the rotation direction E1. In addition, as illustrated in FIG. 3, the driver 10 includes a striking portion-position detection unit 80 that detects a striking portion-position which is a position of the striking portion 12 in the up-down direction M1, and the striking portion-position detection unit 80 includes the blade detector switch 80a that can abut on the driver blade 29 of the striking portion 12.

When the pin wheel 50 rotates in a state of being engaged with the pin wheel 50, the striking portion 12 moves from the standby position to the other (upper) side in the up-down direction M1. On the other hand, when the engagement with the pin wheel 50 is released, the striking portion 12 moves to one (lower) side in the up-down direction M1 by the pressure (biasing force) from the pressure chamber 26 to strike the nail 78. An operation of moving the striking portion 12 to the other (upper) side in the up-down direction Ml and an operation of moving the striking portion 12 to one (lower) side in the up-down direction M1, which are necessary for striking the nail 78, correspond to a striking operation. At this time, the control unit 82 determines whether the striking operation by the striking portion 12 is a first striking operation in which all of the plurality of pins (rotating portion-side engagement portions) is engaged with the racks (striking portion-side engagement portions) of the driver blade 29 (in a predetermined engagement relationship) or a second striking operation in which some of the plurality of pins is not engaged with the racks of the driver blade 29 (not in a predetermined engagement relationship) based on the rotation position of the pin wheel 50 and the striking portion-position of the striking portion 12. The first striking operation is a normal striking operation in which no misalignment occurs in the engagement between the striking portion 12 and the pin wheel 50. On the other hand, the second striking operation is a striking operation in a state where misalignment has occurred in the engagement between the striking portion 12 and the pin wheel 50. That is, by detecting the positions of the striking portion 12 and the pin wheel 50, the driver 10 causes the control unit 82 to determine whether misalignment has occurred in the engagement between the striking portion 12 and the pin wheel 50. The above determination is performed by counting of a rotation position detection element which is a Hall IC.

Note that the misalignment release switch 81 installed in the operation unit 72 of the driver 10 is a switch that starts reverse rotation of the pin wheel 50 by an operation of the operator in a state where the operator turns on the push lever 79 and the trigger 75 when the occurrence of the misalignment is detected in the engagement between the striking portion 12 and the pin wheel 50. Specifically, when the operator operates the misalignment release switch 81 in a state where the operator switches the operation of the electric motor 15 by the push lever 79 and the trigger 75 to the rotation of the electric motor 15, the misalignment release switch 81 starts the reverse rotation of the pin wheel 50. That is, when the operator operates the misalignment release switch 81, the pin wheel 50 can be reversed (rotated opposite to the rotation direction E1) to release the misalignment in the engagement between the striking portion 12 and the pin wheel 50.

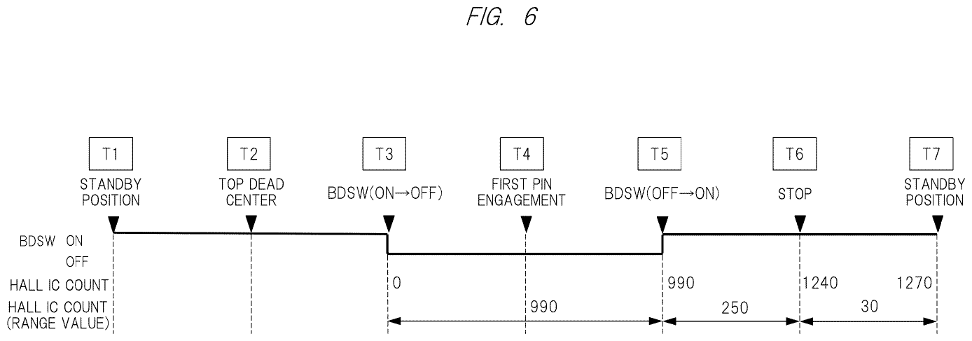

Next, a sequence in the case of normal engagement (first striking operation) in which no misalignment occurs in the engagement between the driver blade 29 and the pin wheel 50 will be described with reference to FIGS. 6 to 9 and 15.

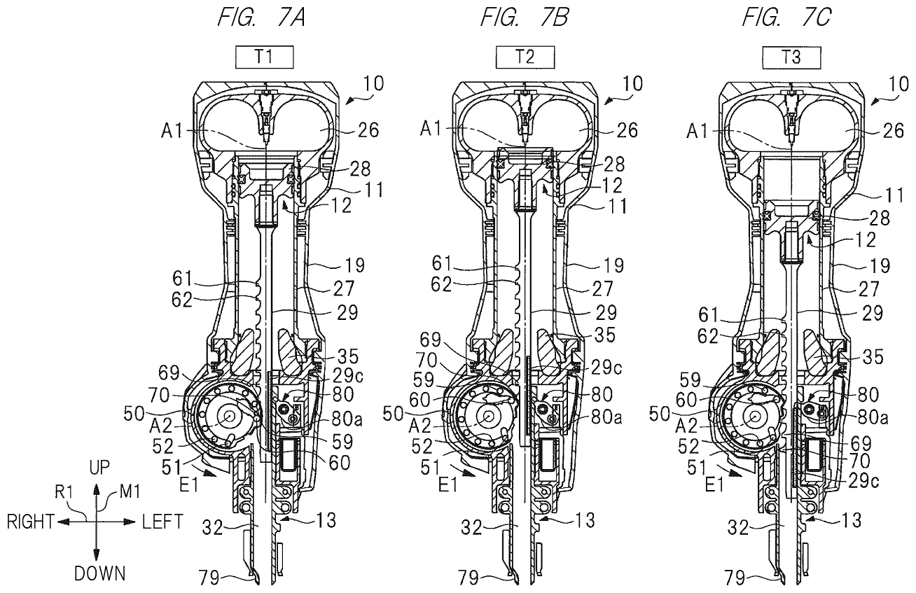

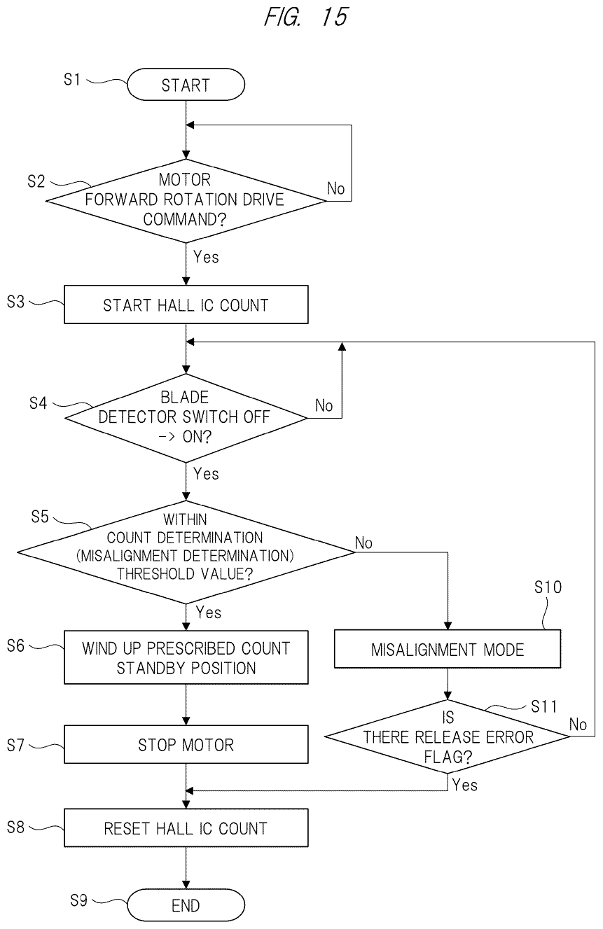

In “start” of Step S1 illustrated in FIG. 15, when detecting at least one of a case where no operational force is applied to the trigger 75 and a case where the push lever 79 is not pressed against the mating material 30, the control unit 82 stops the supply of electric power to the electric motor 15. Therefore, the electric motor 15 is stopped, and the striking portion 12 is stopped at the standby position as at a time point Tl in FIG. 7A. At the time point T1, which is the standby position, the blade detector switch (BDSW) 80a is in an ON state because of being engaged with the rib 29c of the driver blade 29.

When detecting that the operational force is applied to the trigger 75 and that the push lever 79 is pressed against the mating material 30, the control unit 82 executes the determination of “motor forward rotation drive command” in Step S2 of FIG. 15. In a case where the determination is Yes, a voltage is applied from the power source unit 14 to the electric motor 15, and the electric motor 15 is rotated forward. As a result, the strking operatiom is started. When the determination of “motor forward rotation drive command” in Step S2 is No, the determination of “motor forward rotation drive command” in Step S2 is executed again. When the electric motor 15 rotates forward, the rotational force of the electric motor 15 is transmitted to the rotation shaft 46 via the speed reduction mechanism (not illustrated). Then, the rotation shaft 46 and the pin wheel 50 start to rotate counterclockwise (rotation direction E1) in FIG. 3. As a result, the striking portion 12 rises. When the striking portion 12 rises, the gas pressure in the pressure chamber 26 illustrated in FIG. 3 rises. The speed reduction mechanism makes the rotation speed of the pin wheel 50 lower than the rotation speed of the electric motor 15. As illustrated in FIG. 7B, the raised striking portion 12 reaches the top dead center at a time point T2.

Thereafter, when a final pin 60 in the rotation direction E1 of the pin wheel 50 illustrated in FIG. 3 separates from a final rack 70, the striking portion 12 is lowered by the gas pressure of the pressure chamber 26. That is, the position of the striking portion 12 at a time point when the pin 60 is separated from the rack 70 is the top dead center. The striking portion 12 is lowered by the gas pressure of the pressure chamber 26. At a time point T3 during lowering of the striking portion 12, as illustrated in FIG. 7C, the engagement between the blade detector switch 80a and the rib 29c of the driver blade 29 is released, and the blade detector switch 80a is switched OFF as illustrated in FIG. 6. At a time point T3 at which the blade detector switch 80a is switched off, “the Hall IC count is started” in Step S3 of FIG. 15, and the Hall IC count at the time point T3 is set to 0 (zero). Thereafter, when the striking portion 12 lowers, the driver blade 29 strikes one nail 78 located in the injection path 37, and the nail 78 is driven into the mating material 30.

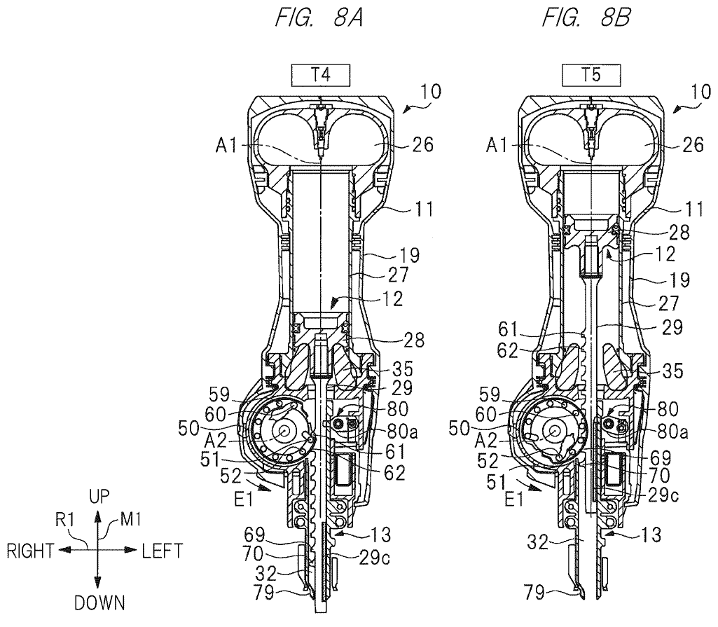

After the nail 78 is driven into the mating material 30, the piston 28 collides with the bumper 35 and reaches the bottom dead center as illustrated in FIG. 8A.

The control unit 82 continues the rotation of the electric motor 15 even after the striking portion 12 drives the nail 78 and reaches the bottom dead center. Therefore, the pin wheel 50 rotates counterclockwise (rotation direction E1) illustrated in FIG. 3, and the pin 51 approaches the rack 61.

When the pin 51 is engaged with the rack 61 (first pin engagement at a time point T4 in FIG. 6), the striking portion 12 starts to move from the bottom dead center toward the standby position by the rotational force of the pin wheel 50. At this time point T4, the blade detector switch 80a is in an off state because of not being engaged with the rib 29c of the driver blade 29.

Subsequently, when the striking portion 12 rises toward the standby position, the blade detector switch 80a starts to engage with the rib 29c of the driver blade 29 at a time point T5 as illustrated in FIG. 8B. That is, as illustrated at the time point T5 in FIG. 6, the blade detector switch (BDSW) 80a is switched ON. That is, the determination of “blade detector switch OFF→ON?” illustrated in Step S4 of FIG. 15 is executed. In a case where the determination of Step S4 is Yes, “within count determination (misalignment determination) threshold value?” in Step S5 is executed. Here, the control unit 82 determines whether or not the misalignment has occurred in the engagement between the striking portion 12 and the pin wheel 50. On the other hand, in a case where the determination in Step S4 is No, the determination of the blade detector switch OFF→ON? in Step S4 is executed again. In Step S5, the control unit 82 determines the misalignment by using the Hall IC count at the time point T5 in FIG. 6.

The Hall IC count at the time point T5 in FIG. 6 is 990. Note that a threshold value for determining the misalignment is set in advance based on the dimensions, the reduction ratio, and the like of each member, and for example, Hall IC counts 930 to 1050 are set. As a result, for example, in a case where the Hall IC count at the time point T5 is 990, this count is within a range of threshold values 930 to 1050, and thus, the control unit 82 determines that no misalignment has occurred (it is determined that the engagement between the striking portion 12 and the pin wheel 50 is normal engagement). That is, at the time point T5 in FIG. 6, the control unit 82 determines that the engagement between the striking portion 12 and the pin wheel 50 is not misalignment but a normal engagement. As described above, the control unit 82 has cumulative information regarding the drive of the electric motor 15, which is accumulated while the electric motor 15 is driven in the striking operation of the striking portion 12, and detects the rotation position of the pin wheel 50 based on the cumulative information. In the present first embodiment, the cumulative information is the rotation amount of the electric motor 15.

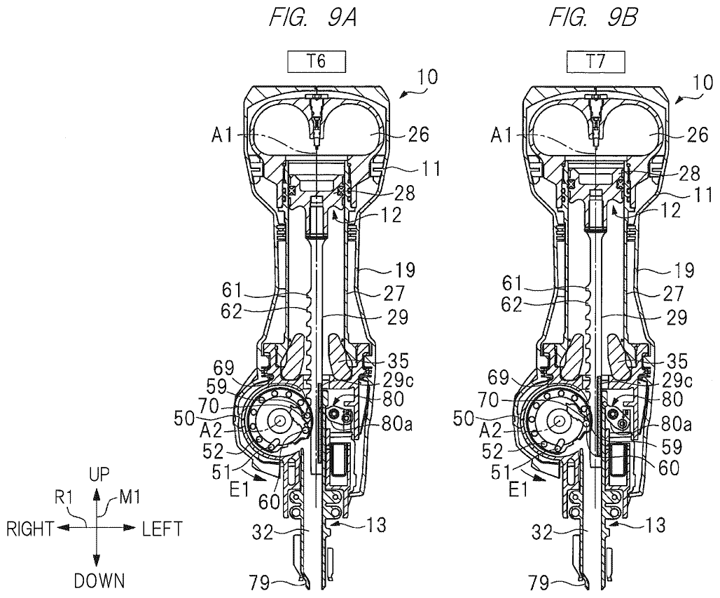

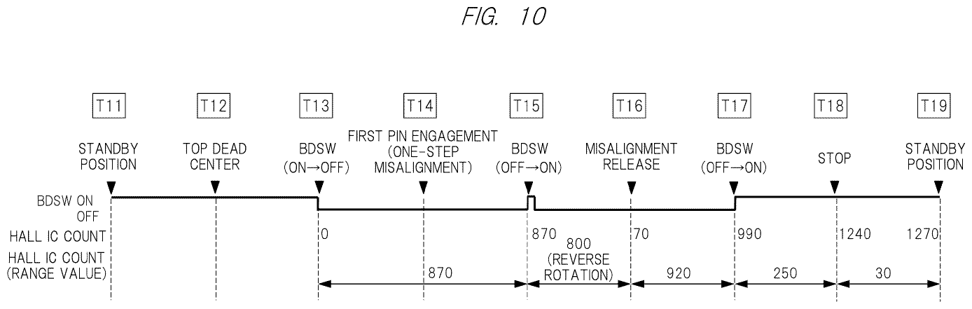

Note that, at the time point T5, since the striking portion 12 has not yet reached the standby position in the striking operation of the striking portion 12, the control unit 82 determines whether the striking operation is the first striking operation (striking operation by normal engagement in which no misalignment has occurred) or the second striking operation (striking operation by misalignment) before the striking portion 12 reaches the standby position. Here, the position of the striking portion 12 at the time point T5 when the blade detector switch (BDSW) 80a is switched from OFF to ON is a position at which the control unit 82 determines which one of the first striking operation and the second striking operation is executed. Then, assuming that the position of the striking portion 12 at the time point T5 in FIG. 8B is a predetermined position, the blade detector switch 80a of the striking portion-position detection unit 80 abuts on the striking portion 12 when the striking portion 12 is located above the predetermined position in the up-down direction M1 in FIG. 8B as illustrated in FIG. 9A at a time point T6.

Subsequently, in a case where “within count determination (misalignment determination) threshold value?” in Step S5 of FIG. 15 is Yes, “winding-up of the prescribed count standby position” in Step S6 of FIG. 15 is executed. The prescribed count is set in advance based on the dimensions, the reduction ratio, and the like of each member, and is the Hall IC count 250 in the present first embodiment. Note that, the striking operation in a case where “within count determination (misalignment determination) threshold value?” in Step S5 is No will be described in the misaligned engagement using FIGS. 10 to 14 which will be described later.

By executing “winding-up of prescribed count standby position” in Step S6, the electric motor 15 is rotated forward to raise the striking portion 12 toward the standby position. Then, the rotation of the electric motor 15 is stopped at the time point T6 in FIG. 9A. That is, “motor stop” in Step S7 of FIG. 15 is executed. Specifically, when the Hall IC count reaches 1240 at the time point T6 in FIG. 6, the rotation of the electric motor 15 is braked. Thereafter, the electric motor 15 continues to rotate due to inertia, and the striking portion 12 stops at the standby position indicated by a time point T7 in FIG. 9B. The Hall IC count at the time point T7 is 1270, and the electric motor 15 further rotates to an extent that the Hall IC count increases from 1240 to 1270 due to inertia after the brake is applied at the time point T6 and stops. The standby position in the striking operation of the striking portion 12 illustrated at the time point T7 in FIG. 9B is located above the predetermined position of the striking portion 12 illustrated at the time point T5 in FIG. 8B in the up-down direction M1.

Subsequently, the Hall IC count reset in Step 8 is executed. That is, when the striking portion 12 stops at the standby position, the Hall IC count is reset. As a result, Step S9 ends.

Next, a sequence in the case of including the misaligned engagement (second striking operation) when the misalignment has occurred in the engagement between the driver blade 29 and the pin wheel 50 will be described with reference to FIGS. 10 to 17.

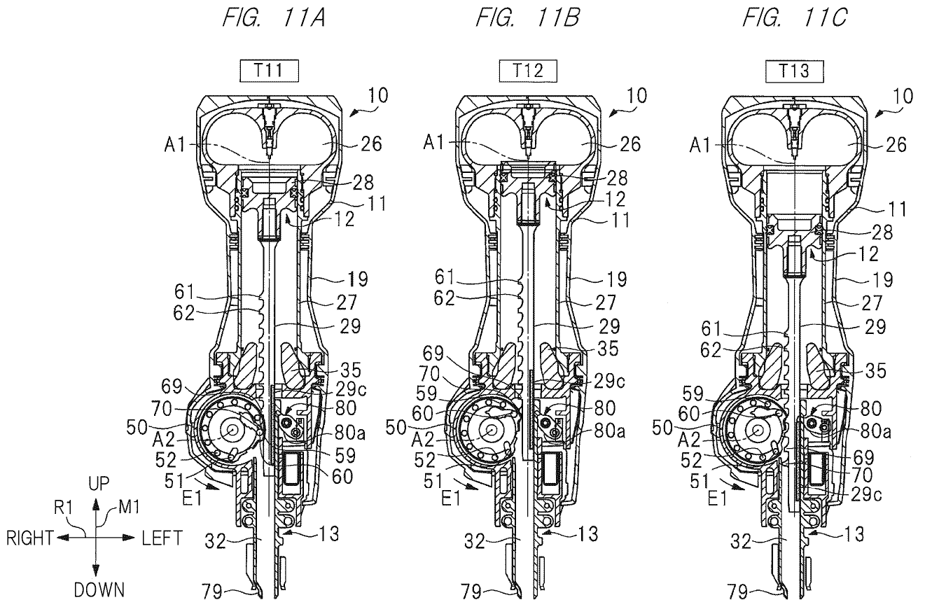

In “start” of Step S1 illustrated in FIG. 15, when detecting at least one of a case where no operational force is applied to the trigger 75 and a case where the push lever 79 is not pressed against the mating material 30, the control unit 82 stops the supply of electric power to the electric motor 15. Therefore, the electric motor 15 is stopped, and the striking portion 12 is stopped at the standby position as at a time point T11 in FIG. 11A. At the time point T11, which is the standby position, the blade detector switch (BDSW) 80a is in the ON state because of being engaged with the rib 29c of the driver blade 29.

When detecting that the operational force is applied to the trigger 75 and that the push lever 79 is pressed against the mating material 30, the control unit 82 executes the determination of “motor forward rotation drive command” in Step S2 of FIG. 15. In a case where the determination is Yes, a voltage is applied from the power source unit 14 to the electric motor 15, and the electric motor 15 is rotated forward. As a result, the striking operation is started. When the determination of “motor forward rotation drive command” in Step S2 is No, the determination of “motor forward rotation drive command” in Step S2 is executed again. When the electric motor 15 rotates forward, the rotational force of the electric motor 15 is transmitted to the rotation shaft 46 via the speed reduction mechanism (not illustrated). Then, the rotation shaft 46 and the pin wheel 50 start to rotate counterclockwise (rotation direction E1) in FIG. 3. As a result, the striking portion 12 rises. When the striking portion 12 rises, the gas pressure in the pressure chamber 26 illustrated in FIG. 3 rises. The speed reduction mechanism makes the rotation speed of the pin wheel 50 lower than the rotation speed of the electric motor 15. As illustrated in FIG. 11B, the raised striking portion 12 reaches the top dead center at a time point T12.

Thereafter, when the final pin 60 in the rotation direction E1 of the pin wheel 50 illustrated in FIG. 3 separates from the final rack 70, the striking portion 12 is lowered by the gas pressure of the pressure chamber 26. That is, the position of the striking portion 12 at a time point when the pin 60 is separated from the rack 70 is the top dead center. The striking portion 12 is lowered by the gas pressure of the pressure chamber 26. At a time point T13 during lowering of the striking portion 12, as illustrated in FIG. 11C, the engagement between the blade detector switch 80a and the rib 29c of the driver blade 29 is released, and the blade detector switch 80a is switched OFF as illustrated in FIG. 10. At the time point T13 at which the blade detector switch 80a is switched off, “the Hall IC count is started” in Step S3 of FIG. 15, and the Hall IC count at the time point T13 is set to 0 (zero). Thereafter, when the striking portion 12 lowers, the driver blade 29 strikes one nail 78 located in the injection path 37, and the nail 78 is driven into the mating material 30.

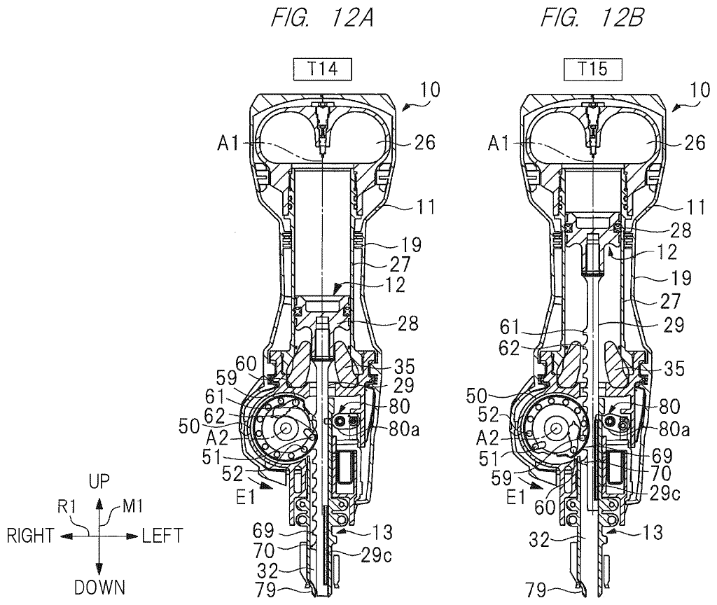

After the nail 78 is driven into the mating material 30, the piston 28 collides with the bumper 35 and reaches the bottom dead center as illustrated in FIG. 12A.

The control unit 82 continues the rotation of the electric motor 15 even after the striking portion 12 drives the nail 78 and reaches the bottom dead center. Therefore, the pin wheel 50 rotates counterclockwise (rotation direction E1) illustrated in FIG. 3, and the pin of the pin wheel 50 approaches the rack of the driver blade 29.

Here, in a case where the rebound of the driver blade 29 from the mating material 30 due to the hardness of the mating material 30 is large, or in a case where the nail 78 is jammed in the injection path 37, the driver blade 29 is engaged with the striking portion 12 at a position above the appropriate position, whereby misalignment occurs in the engagement between the striking portion 12 and the pin wheel 50. For example, the misalignment occurs in engagement of the pin 51 of the pin wheel 50 illustrated in FIG. 3 with the rack 62 of the driver blade 29. That is, the first pin engagement (one-step misalignment) illustrated at a time point T14 in FIG. 10 occurs.

Then, when the pin 51 is engaged with the rack 62 (one-step misaligned engagement at the time point T14 in FIG. 10), the striking portion 12 starts to move toward the standby position by the rotational force of the pin wheel 50. At this time point T14, the blade detector switch 80a is in the off state, as illustrated in FIG. 10, because of not being engaged with the rib 29c of the driver blade 29.

Subsequently, when the striking portion 12 rises toward the standby position, the blade detector switch 80a starts to engage with the rib 29c of the driver blade 29 at a time point T15 as illustrated in FIG. 12B. That is, as illustrated at the time point T15 in FIG. 10, the blade detector switch (BDSW) 80a is switched ON. That is, the determination of blade detector switch OFF→ON? illustrated in Step S4 of FIG. 15 is executed. In a case where the determination of Step S4 is Yes, “within count determination (misalignment determination) threshold value?” in Step S5 is executed. Here, the control unit 82 determines whether or not the misalignment has occurred in the engagement between the striking portion 12 and the pin wheel 50. On the other hand, in a case where the determination in Step S4 is No, the determination of the blade detector switch OFF→ON? in Step S4 is executed again. In Step S5, the control unit 82 determines the misalignment by using the Hall IC count at the time point T15 in FIG. 10.

The Hall IC count at the time point T15 in FIG. 10 is 870. Note that a threshold value for determining the misalignment is set in advance based on the dimensions, the reduction ratio, and the like of each member, and for example, Hall IC counts 930 to 1050 are set. As a result, for example, in a case where the Hall IC count at the time point T15 is 870, this count is outside of the range of the threshold values 930 to 1050 and smaller than 930, which is the lower limit of the threshold value, so that the control unit 82 determines that the misalignment has occurred (it is determined that the engagement between the striking portion 12 and the pin wheel 50 is misaligned engagement). That is, at the time point T15 in FIG. 10, the control unit 82 determines that the engagement between the striking portion 12 and the pin wheel 50 is misaligned engagement. As described above, the control unit 82 has cumulative information regarding the drive of the electric motor 15, which is accumulated while the electric motor 15 is driven in the striking operation of the striking portion 12, and detects the rotation position of the pin wheel 50 based on the cumulative information. In the present first embodiment, the cumulative information is the rotation amount of the electric motor 15.

Note that, at the time point T15, since the striking portion 12 has not yet reached the standby position in the striking operation of the striking portion 12, the control unit 82 determines whether the striking operation is the first striking operation (striking operation by normal engagement in which no misalignment has occurred) or the second striking operation (striking operation by misalignment) before the striking portion 12 reaches the standby position. Here, the position of the striking portion 12 at the time point T15 when the blade detector switch (BDSW) 80a is switched from OFF to ON is a position at which the control unit 82 determines which one of the first striking operation and the second striking operation is executed. Then, assuming that the position of the striking portion 12 at the time point T15 in FIG. 12B is a predetermined position, the blade detector switch 80a of the striking portion-position detection unit 80 abuts on the striking portion 12 when the striking portion 12 is located above the predetermined position in the up-down direction M1. In other words, in a case where the rotation position of the pin wheel 50 when the position of the striking portion 12 is the predetermined position is outside of the range of the set threshold value of the Hall IC count, the control unit 82 determines that the striking operation of the striking portion 12 is the second striking operation (striking operation by the misalignment).

Here, the determination of the control unit 82 in a case where the Hall IC count at the time point T15 in FIG. 10 is outside of the range of the threshold values 930 to 1050 and larger than 1050, which is the upper limit of the threshold value, will be described later.

Subsequently, in a case where “within count determination (misalignment determination) threshold value?” in Step S5 of FIG. 15 is Yes, the striking portion 12 is raised toward the standby position and stopped at the standby position by the same operation as at the time point T6 and the time point T7 in FIG. 6. That is, Steps S6 to S9 in FIG. 15 are executed.

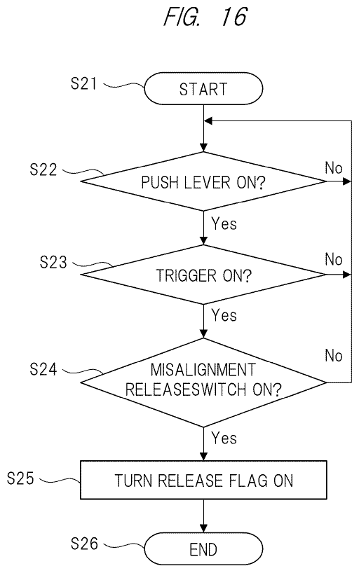

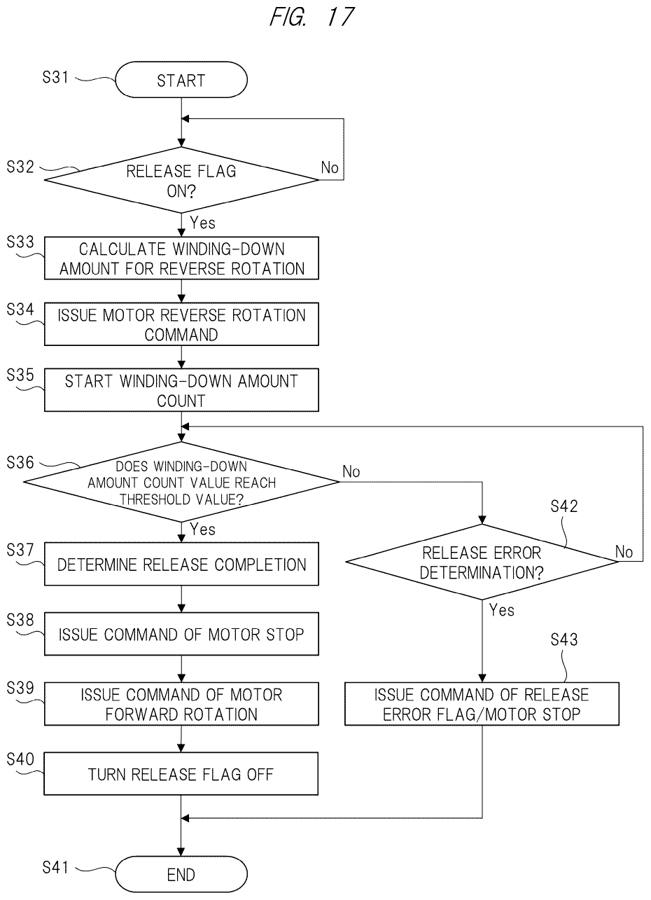

On the other hand, in a case where “within count determination (misalignment determination) threshold value?” in Step S5 is No, “misalignment mode” in Step S10 is executed. That is, in a case where the control unit 82 determines that the engagement between the striking portion 12 and the pin wheel 50 is the misaligned engagement, “misalignment mode” of Step S10 is executed. Details of the control in “misalignment mode” in Step S10 are described in the flowcharts of FIGS. 16 and 17. First, at the time point T15 in FIG. 10, the operator turns on the misalignment release switch 81 illustrated in FIG. 1. At this time, in the releasing operation of the misalignment by turning on the misalignment release switch 81, the determination of “push lever ON” in Step S22 is executed by “start” in Step 21 in FIG. 16. Subsequently, in a case where the determination of “push lever ON” in Step S22 is Yes, the determination of “trigger ON” in Step S23 is executed. Furthermore, in a case where the determination of “trigger ON” in Step S23 is Yes, the determination of “misalignment release switch ON” in Step S24 is executed. Then, in a case where the determination of “misalignment release switch ON” in Step S24 is Yes, “release flag ON” in Step S25 is executed, and “end” in Step S26 is obtained.

That is, when the control unit 82 detects that the push lever 79 is pressed against the mating material 30 by the operator, that the operational force is applied to the trigger 75 by the operator, and that the misalignment release switch 81 is operated to be turned on by the operator, the release flag ON in Step S25 is executed to start the misalignment release operation. On the other hand, in a case where the determination of “push lever ON” in Step S22, the determination of “trigger ON” in Step S23, and the determination of “misalignment release switch ON” in Step S24 are all No, the determination of push lever ON in Step S22 is executed again each time.

As described above, at the time point T15 in FIG. 10, the operator presses the push lever 79 against the mating material 30, and the operator operates the misalignment release switch 81 to turn on in a state where the operator applies the operational force to the trigger 75, thereby executing the misalignment release operation.

In the misalignment release operation, “misalignment mode” in Step S10 in FIG. 15 is executed, and the misalignment release operation is started by “start” in Step S31 in FIG. 17. Subsequently, the determination of “release flag ON” in Step S32 is executed, and in a case where the determination of “release flag ON” is Yes, “calculation of winding-down amount of reverse rotation” in Step S33 is executed. In a case where the determination of “release flag ON” in Step S32 is No, the determination of “release flag ON” in Step S32 is executed again.

Subsequently, in “calculation of the winding amount of reverse rotation” in Step S33, the calculation is performed based on the value of the Hall IC count when the blade detector switch 80a is switched from OFF to ON at the time point T15 in FIG. 10 each time the blade detector switch 80a is switched. In the present first embodiment, the Hall IC count at the time point T15 in FIG. 10 is 870. In this case, when the pin wheel 50 is reversely rotated while being equivalent to the Hall IC count of 870 in order to release the misalignment, the first pin 51 of the pin wheel 50 and the first rack 61 of the driver blade 29 collide with each other. Thus, the pin wheel 50 is reversely rotated by a value slightly smaller than the Hall IC count of 870 to avoid a collision between the pins 51 of the pin wheel 50 and the rack 61 of the driver blade 29. The number of reverse rotations smaller than the Hall IC count 870 is set in advance based on the dimensions of each member, the reduction ratio, and the like, and in the present first embodiment, the Hall IC count is 70. That is, as illustrated in FIGS. 10, 800 obtained by subtracting 70 from 870 is calculated as the reverse rotation amount, and the pin wheel 50 is reversely rotated by the Hall IC count of 800 to release the misalignment.

Then, “motor reverse rotation command” in Step S34 of FIG. 17 is executed. By executing “motor reverse rotation command” in Step S34, the reverse rotation of the electric motor 15 is started. Further, “start of counting of the winding-down amount” in Step S35 is executed. As a result, the reverse rotation of the pin wheel 50 is started, and the lowering of the striking portion 12 is started. Here, when the control unit 82 determines that the striking operation of the striking portion 12 is the second striking operation (the striking operation by the misalignment), the control unit reversely rotates the pin wheel 50 until the striking portion 12 reaches the bottom dead center position. At this time, as described above, first, the operator operates (switches) the operation of the electric motor 15 by the push lever 79 and the trigger 75 to (reversely) rotate the electric motor 15, and maintains this state, and further operates the misalignment release switch 81, thereby starting the reverse rotation of the pin wheel 50.

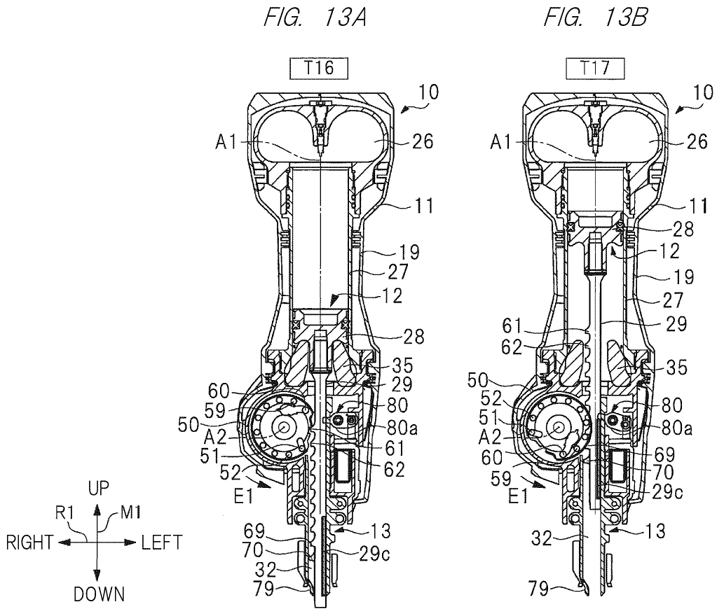

Then, determination that “does winding-down amount count reach a threshold value?” in Step S36 of FIG. 17 is executed. In the present first embodiment, it is determined whether or not the Hall IC count of 800 is counted as the rotation amount for reversely rotating the pin wheel 50. In case where the determination in Step S36 is Yes, the striking portion 12 reaches the bottom dead center position as illustrated at a time point T16 in FIG. 13A, and the misalignment is released as illustrated at the time point T16 in FIG. 10. The Hall IC count at this time is 70 obtained by subtracting 800 from 870. That is, “release completion determination” in Step S37 is executed, and “motor stop command” in Step S38 is further executed. Here, the reverse rotation of the electric motor 15 is stopped. Subsequently, “motor forward rotation command” in Step S39 is executed to start the rotation (forward rotation) of the electric motor 15. Thereafter, “release flag OFF” in Step S40 is executed, and “end” of Step S41 is obtained. That is, the misalignment mode is ended.

On the other hand, in a case where the determination in Step S36 is No, “release error determination?” in Step S42 is executed. In the release error determination, in a case where the time required for the winding-down amount count to reach the threshold value is equal to or longer than a threshold value, in a case where the current value of the electric motor 15 becomes equal to or larger than the threshold value during the winding-down, or in a case where the rotation of the electric motor 15 is locked and the count of the winding-down amount does not change, determination is made as Yes, “release error flag/motor stop command” in Step S43 is executed to stop the electric motor 15, and “end” in Step S41 is obtained. Note that in a case where “release error determination” in Step S42 is No, the determination of “does winding-down amount count reach the threshold value?” in Step S36 is executed again.

As described aboave, the misalignment mode is ended, and next, determination of “is there release error flag?” in Step S11 of FIG. 15 is executed. In a case where the determination of “is there release error flag?” in Step S11 is Yes, “Hall IC count reset” in Step S8 is executed. On the other hand, in a case where the determination of “is there release error flag?” in Step S11 is No, the normal rotation of the electric motor 15 is continued to raise the striking portion 12.

Thereafter, determination of “blade detector switch OFF-ON?” illustrated in Step S4 of FIG. 15 is executed again. Then, in a case where the determination in Step S4 is Yes, “within count determination (misalignment determination) threshold value?” in Step S5 is executed. Here, the control unit 82 determines whether or not the misalignment has occurred in the engagement between the striking portion 12 and the pin wheel 50. In Step S5, the control unit 82 determines the misalignment by using the Hall IC count at a time point T17 in FIG. 10. The position of the striking portion 12 at the time point T17 is a position where the blade detector switch 80a is switched from OFF to ON as illustrated in FIG. 13B.

As illustrated at the time point T17 in FIG. 10, the Hall IC count at the time point T17 when the blade detector switch 80a is switched from OFF to ON is 990. At this time, since the Hall IC count of 930 to 1050 is set in advance as the threshold value for determining the misalignment, the determination at the time point T17 is within the range of the threshold, and the control unit 82 determines that the striking operation of the striking portion 12 is the first striking operation (the striking operation by the normal engagement in which the misalignment does not occur).

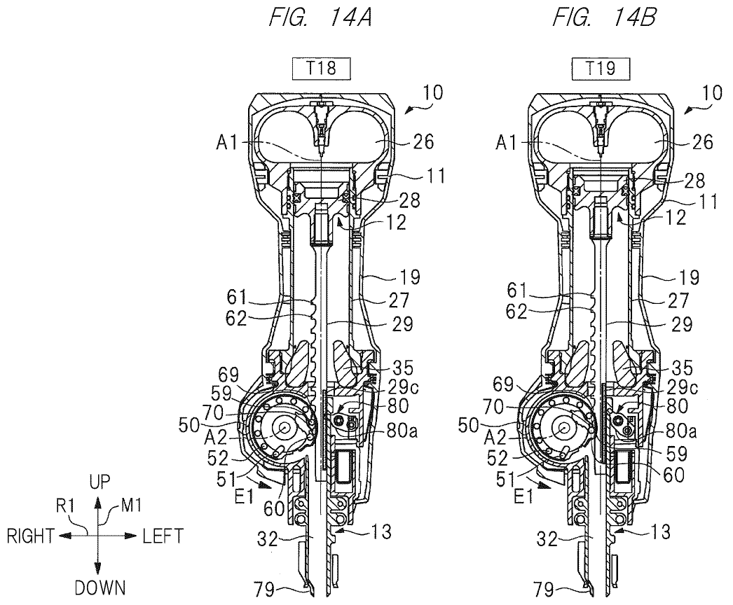

Subsequently, in a case where “within count determination (misalignment determination) threshold value?” in Step S5 of FIG. 15 is Yes, “winding-up of the prescribed count standby position” in Step S6 of FIG. 15 is executed. By executing “winding-up of prescribed count standby position” in Step S6, the electric motor 15 is rotated forward to raise the striking portion 12 toward the standby position. Then, the rotation of the electric motor 15 is stopped at a time point T18 in FIG. 14A. That is, “motor stop” in Step S7 of FIG. 15 is executed. Specifically, when the Hall IC count reaches 1240 at the time point T18 in FIG. 10, the rotation of the electric motor 15 is braked. Thereafter, the electric motor 15 rotates due to the inertia, and the striking portion 12 stops at the standby position indicated by a time point T19 in FIG. 14B. The Hall IC count at the time point T19 is 1270, and the electric motor 15 further rotates to an extent that the Hall IC count increases from 1240 to 1270 due to inertia after the brake is applied at the time point T18 and stops.

Subsequently, the Hall IC count reset in Step S8 is executed. That is, when the striking portion 12 stops at the standby position, the Hall IC count is reset. As a result, Step S9 ends.

Next, a case where the numerical value of the Hall IC count is outside of the range of the threshold values 930 to 1050 set in advance and is larger than 1050, which is the upper limit of the threshold value, in the determination of the misalignment at the time point T15 in FIG. 10 will be described. In a case where the determination of the Hall IC count is larger than the threshold values 930 to 1050 set in advance in the determination of the misalignment at the time point T15 in FIG. 10, the control unit 82 determines that the first pin damage has occurred.

Here, the first pin damage will be described. The first pin (pin 51) may be damaged due to long-term use of the driver 10 or the occurrence of misalignment. When the first pin is damaged, the second pin (pin 52) and the first rack (rack 61) are engaged at the start of winding-up (pushing up) of the striking portion 12, and the 10th pin (final pin (pin 60) ) and the ninth rack (rack 69 second from the bottom) are engaged immediately before driving. Note that in the case of misalignment, the first pin (pin 51) and the second rack (rack 62) are engaged at the start of winding-up of the striking portion 12, and the ninth pin (pin 59 second from the rear) and the 10th rack (final rack (rack 70)) are engaged immediately before driving.

In the motor control of the present first embodiment, as control for stopping the striking portion 12 at the standby position, the position of the striking portion 12 in the up-down direction M1 is set as a motor stop condition. Therefore, comparing the state where the striking portion 12 is located at the standby position between the normal state and the state where the first pin is damaged, the state where the striking portion rotates one pin more in the state where the first pin is damaged is obtained. At this time, since the length of the ninth rack (rack 69 second from the bottom) is shorter than the length of the 10th rack (final rack (rack 70)), the final pin (pin 60) is separated from the ninth rack (rack 69 second from the bottom) at the standby position when the first pin is damaged. As a result, the driver blade 29 is actually driven before reaching the standby position. That is, when the first pin is damaged, double driving in which driving is performed twice occurs in one driving process.

Therefore, as a countermeasure against the damage to the first pin, in the present first embodiment, a threshold value for determining a first pin damage error is set in the misalignment determination at a time point when the blade detector switch 80a is switched from OFF to ON. For example, the Hall IC count of 1051 to 1460 is set as a threshold value for determining the first pin damage error. That is, in a case where the Hall IC count is within the range of 1051 to 1460 in the misalignment determination at the time point when the blade detector switch 80a is switched from OFF to ON, it is determined that the first pin damage error has occurred, and braking of the rotation of the electric motor 15 is started. At this time, the misalignment release operation is not executed. Note that in a case where the Hall IC count exceeds 1460 during the operation of the electric motor 15 regardless of the detection by the blade detector switch 80a, a release error occurs.

According to the driver 10 of the present first embodiment, when the control unit 82 detects misalignment in the engagement between the pin of the pin wheel 50 and the rack of the driver blade 29, the control unit 82 reversely rotates the electric motor 15 to lower the driver blade 29 to the bottom dead center. Thus, it is possible to release the misalignment between the pin and the rack. After releasing the misalignment, the control unit 82 causes the electric motor 15 to rotate forward to engage the first pin (pin 51) and the first rack (rack 61), thereby raising the striking portion 12 to the standby position. As described above, it is possible to suppress the occurrence of damage of the pin by releasing the misalignment under the control of the control unit 82.

As a result, it is possible to reduce the frequency of component replacement in the driver 10 and to improve the convenience of the driver 10.

Further, in the determination of the misalignment by the control unit 82, the rotation amount of the pin wheel 50 (the rotation amount of the electric motor 15) based on the position of the driver blade 29 in the up-down direction M1 is determined by the threshold value of the Hall IC count to determine whether or not misalignment has occurred. That is, since the determination of the misalignment is made by the threshold value of the Hall IC count set in advance, it is possible to execute the determination quickly, and to enhance the accuracy of the determination.

In addition, when the misalignment is released, the winding-down amount of reverse rotation of the electric motor 15 is calculated based on the numerical value of the Hall IC count at a time point when the blade detector switch 80a is switched from OFF to ON (at the time of determination of misalignment), whereby it is possible to calculate the winding-down amount that can be reliably released, with high accuracy.

At this time, in the calculation of the winding-down amount, by setting the winding-down amount to a slightly smaller amount than the winding-down amount when the misalignment is detected, it is possible to avoid the collision between the first pin 51 of the pin wheel 50 and the first rack 61 of the driver blade 29 during the reverse rotation of the electric motor. As a result, it is possible to suppress the damage of the pin or the rack.

Further, when releasing the misalignment, the operator operates the misalignment release switch 81 of the operation unit 72 to start the misalignment releasing operation. At this time, the operator presses the push lever 79 against the mating material 30 to turn on, and further operates the misalignment release switch 81 in a state where the trigger 75 is operated to turn on, so that the misalignment release operation starts. As a result, it is possible to eliminate an erroneous operation of the misalignment release and to enhance the safety of the driver 10. That is, it is possible to prevent the misalignment release operation from being started in a state not intended by the operator.

### Second Embodiment

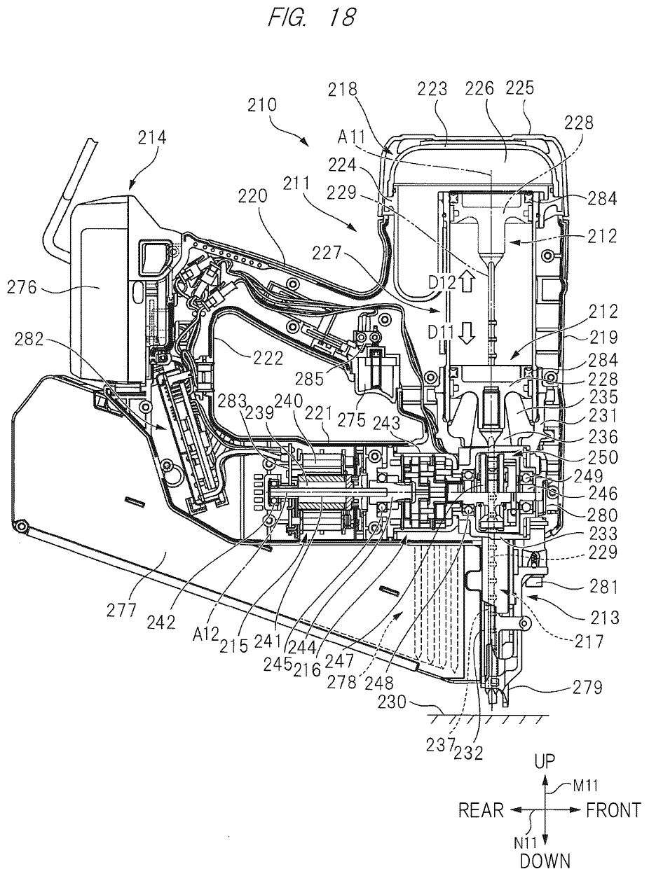

A driver (working machine) 210 illustrated in FIG. 18 is an air compression type working machine, and includes a housing 211, a striking portion 212, a nose portion 213, a power source unit 214, an electric motor (motor) 215, a speed reduction mechanism 216, a winding-up mechanism 217, and a pressure accumulation container 218. The housing 211 is an outer shell element of the driver 210, and includes a cylinder case 219, a handle 220, a motor case 221, and a mounting portion 222. The cylinder case 219 has a tubular shape, and the handle 220 and the motor case 221 are connected to the cylinder case 219. In addition, the mounting portion 222 is connected to the handle 220 and the motor case 221.

The power source unit 214 can be attached to and detached from the mounting portion 222. The electric motor 215 is disposed in the motor case 221. The pressure accumulation container 218 includes a cap 223 and a holder 224 to which the cap 223 is attached. A head cover 225 is attached to the cylinder case 219, and the pressure accumulation container 218 is disposed over the inside of the cylinder case 219 and the inside of the head cover 225.

Furthermore, a cylinder 227 is accommodated in the cylinder Case 219. The cylinder 227 is made of metal, for example, aluminum or iron. The cylinder 227 is positioned in a direction along a center line All with respect to the cylinder case 219 and a radial direction. The center line All passes through the center of the cylinder 227. The radial direction is a radial direction of a virtual circle centered on the center line A11. In addition, a pressure chamber 226 is formed over the inside of the pressure accumulation container 218 and the inside of the cylinder 227. The pressure chamber 226 is filled with a compressed gas. As the compressed gas, an inert gas can be used in addition to air. The inert gas includes, for example, a nitrogen gas and a rare gas. In a present second embodiment, an example in which the pressure chamber 226 is filled with air will be described. Note that the pressure chamber 226 is also a biasing portion that biases the striking portion 212 downward (toward one side) in the up-down direction (first direction).

The striking portion 212 is disposed from the inside to the outside of the housing 211. The striking portion 212 includes a piston 228 and a driver blade 229. The piston 228 is operable in the cylinder 227 in the direction along the center line All. An annular seal member 284 is attached to an outer peripheral surface of the piston 228. The seal member 284 is in contact with the inner peripheral surface of the cylinder 227 to form a seal surface. The driver blade 229 is made of, for example, metal, non-ferrous metal, or steel. The piston 228 and the driver blade 229 are provided as separate members, and the piston 228 and the driver blade 229 are joined.

Thus, the striking portion 212 can strike a nail (fastener) 278 by moving downward (toward one side) in the up-down direction (first direction).

The nose portion 213 is disposed over the inside and the outside of the cylinder case 219. The nose portion 213 includes a bumper support portion 231, an injection portion 232, and a columnar portion 233. The bumper support portion 231 has a cylindrical shape. In addition, a bumper 235 is disposed in the bumper support portion 231. The bumper 235 may be made of either synthetic rubber or silicone rubber. The bumper 235 has a guide hole 236. The center line All passes through the guide hole 236. The driver blade 229 is disposed in the guide hole of the bumper support portion 231 and in the guide hole 236. The striking portion 212 can operate in a driving direction D11 and a return direction D12 along the center line A11. The driving direction D11 and the return direction D12 are opposite to each other. The driving direction D11 is a direction in which the piston 228 approaches the bumper 235. The return direction D12 is a direction in which the piston 228 separates from the bumper 235. The striking portion 212 is constantly biased in the driving direction D11 by the gas pressure of the pressure chamber 226. The operation of the striking portion 212 in the driving direction D11 can be defined as lowering. The operation of the striking portion 212 in the return direction D12 can be defined as rising. The driving direction D11 is the same as the downward (one) side of the up-down direction (first direction). The return direction D12 is the same as the upward (other) side of the up-down direction (first direction).

The injection portion 232 is connected to the bumper support portion 231 and protrudes from the bumper support portion 231 in the direction along the center line A11. The injection portion 232 has an injection path 237, and the injection path 237 is provided along the center line A11. The driver blade 229 can be operated in the direction along the center line All in the injection path 237.

The electric motor 215 is disposed in the motor case 221. The electric motor 215 includes a rotor 239 and a stator 240. The stator 240 is attached to the motor case 221. The rotor 239 is attached to a rotor shaft 241, and an end portion of the rotor shaft 241 is rotatably supported by the motor case 221 via a bearing 242. The electric motor 215 is a brushless motor, and when a voltage is applied to the electric motor 215, the rotor 239 rotates about a center line A12.

Furthermore, a gear case 243 is provided in the motor case 221. The gear case 243 has a columnar shape. A speed reduction mechanism 216 is provided in the gear case 243. The speed reduction mechanism 216 includes a plurality of sets of planetary gear mechanisms. An input element of the speed reduction mechanism 216 is joined to the rotor shaft 241 via a power transmission shaft 244. The power transmission shaft 244 is rotatably supported by a bearing 245.

In addition, a rotation shaft 246 is provided in the columnar portion 233. The rotation shaft 246 is rotatably supported by bearings 248 and 249. The rotor shaft 241, the power transmission shaft 244, the speed reduction mechanism 216, and the rotation shaft 246 are concentrically disposed about the center line A12. An output element 247 of the speed reduction mechanism 216 and the rotation shaft 246 are concentrically disposed, and the output element 247 and the rotation shaft 246 rotate integrally. The speed reduction mechanism 216 is disposed on a power transmission path from the electric motor 215 to the rotation shaft 246. The winding-up mechanism 217 converts the rotational force of the rotation shaft 246 into a force for biasing the striking portion 212 in the return direction D12.

In addition, the driver 210 is provided with a trigger 275 and a trigger sensor 285. The trigger 275 and the trigger sensor 285 are provided on the handle 220. The trigger sensor 285 detects the presence or absence of the operational force applied to the trigger 275 and outputs a signal corresponding to the detection result.

The power source unit 214 includes an accommodation case 276 and a battery accommodated in the accommodation case 276. The battery includes a plurality of battery cells. These battery cells are secondary batteries that can be charged and discharged, and as the battery cells, known battery cells such as a lithium ion battery, a nickel hydrogen battery, a lithium ion polymer battery, and a nickel cadmium battery can be freely used.

In addition, the driver 210 is provided with a magazine 277. The magazine 277 is supported by the injection portion 232 and the mounting portion 222. A nail (fastener) 278 is accommodated in the magazine 277. The magazine 277 has a feeder, and the feeder feeds the nail 278 in the magazine 277 to the injection path 237. That is, the feeder moves the nail 278 in the magazine 277 to the front side in the front-rear direction N11. Note that the injection portion 232 is made of metal or synthetic resin. A push lever 279 is attached to the injection portion 232. The push lever 279 can be operated within a predetermined range in the direction along the center line A11 with respect to the injection portion 232. An elastic member 280 that biases the push lever 279 in the direction along the center line A11 is provided. The elastic member 280 is, for example, a metal spring, and the elastic member 280 biases the push lever 279 in a direction away from the bumper support portion 231. The push lever 279 comes into contact with the fastener 281 and stops.

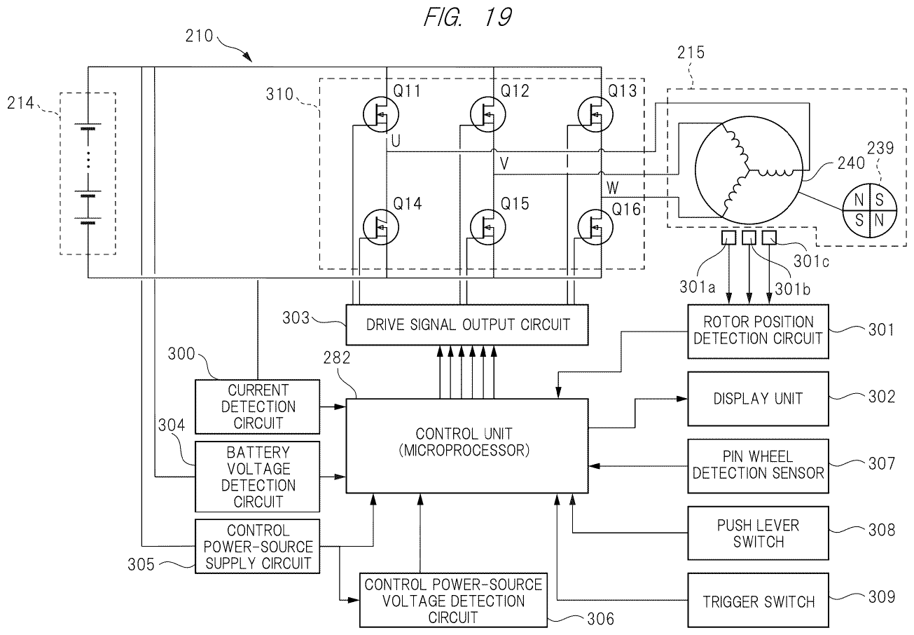

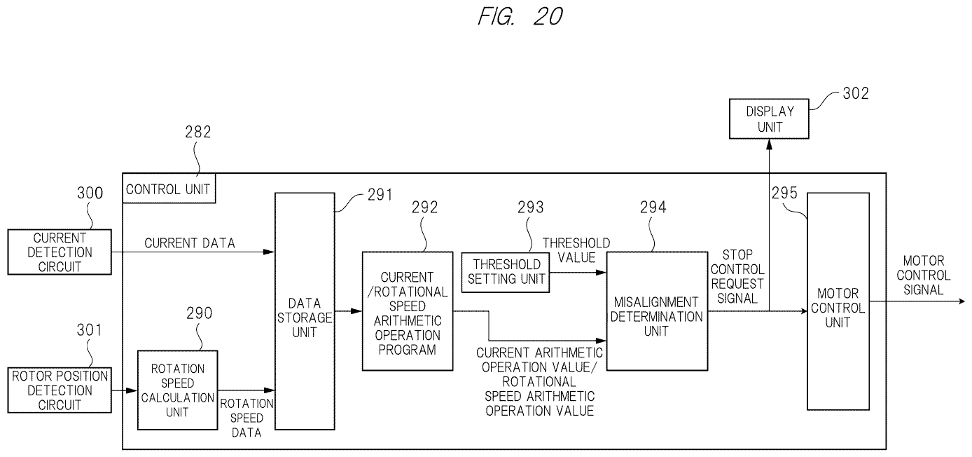

Next, the control unit 282 provided in the driver 210 will be described. The control unit 282 is provided in the mounting portion 222, and mainly controls driving of the electric motor 215. The control unit 282 includes a microprocessor. As illustrated in FIG. 20, the microprocessor includes a rotation speed calculation unit 290, a data storage unit 291, a current/rotational speed computing program 292, a threshold setting unit 293, a misalignment determination unit 294, and a motor control unit 295. As illustrated in FIG. 18, a motor board 283 is provided in the motor case 221. The motor board 283 is provided with an inverter circuit 310 illustrated in FIG. 19. The inverter circuit 310 connects and disconnects the stator 240 of the electric motor 215 and the power source unit 214. The inverter circuit 310 includes a plurality of switching elements Q11, Q12, Q13, Q14, Q15, and Q16, and the plurality of switching elements Q11, Q12, Q13, Q14, Q15, and Q16 can be turned on and off, respectively. The control unit 282 controls the inverter circuit 310 via a drive signal output circuit 303 to control the rotation and stop of the electric motor 215, or the rotation speed of the electric motor 215 and the rotation direction of the electric motor 215.

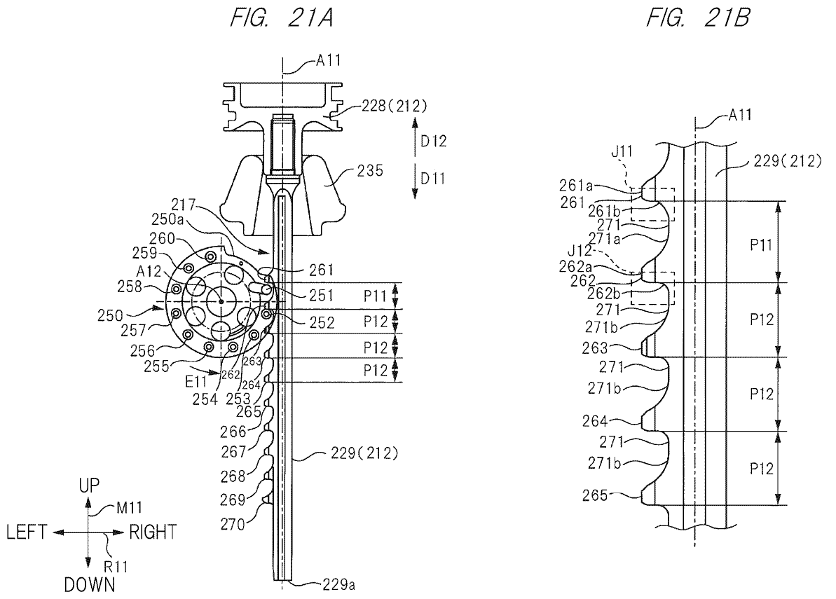

In addition, the driver 210 includes a current detection circuit 300, a rotor position detection circuit 301, a display unit 302, a battery voltage detection circuit 304, a control power-source supply circuit 305, a control power-source voltage detection circuit 306, a pin wheel detection sensor 307, a push lever switch 308, and a trigger switch 309. The pin wheel detection sensor 307 detects a position of the pin wheel (rotating portion) 250 illustrated in FIG. 18 in a rotation direction E11 (see FIG. 21A) and outputs a signal. When the push lever 279 illustrated in FIG. 18 is pressed against a driven material 230, the push lever switch 308 is turned on and outputs a signal. The trigger switch 309 outputs a signal when the trigger sensor 285 is turned on by operating the trigger 275 illustrated in FIG. 18. The rotor position detection circuit 301 detects a position of the rotor 239 in the rotation direction by rotation position detection elements 301a, 301b, and 301c, and outputs a signal. The control unit 282 processes the signal transmitted from the rotor position detection circuit 301 and detects the position of the striking portion 212 in the direction of the center line A11.

Then, signals output from the pin wheel detection sensor 307, the push lever switch 308, and the trigger switch 309 are input to the control unit 282. The control unit 282 processes each input signal and controls the inverter circuit 310. As described above, the control unit 282 controls the stop, rotation, rotation direction, and rotation speed of the electric motor 215.

Here, the determination control of the misalignment by the control unit 282 illustrated in FIG. 20 will be described. The control unit 282, first, stores current data and rotation speed data in the data storage unit 291 based on signals from the current detection circuit 300 and the rotor position detection circuit 301. Then, the stored current data and rotation speed data are input to the current/rotational speed computing program 292. In the current/rotational speed computing program 292, a computing result that can be compared with the current computing value and the rotational speed computing value at the time of normal lift-up (winding-up of the driver blade 229) is calculated by a predetermined computing expression. The misalignment determination unit 294 determines the computing result (current computing value/rotational speed computing value) calculated by the current/rotational speed computing program 292 and the threshold (current computing value/rotational speed computing value) set by the threshold setting unit 293. That is, the misalignment determination unit 294 determines whether the current data transmitted from the current detection circuit 300 and the rotation speed data transmitted from the rotor position detection circuit 301 are in a normal lift-up state or an abnormal lift-up misalignment state. The state of the misalignment at the time of lift-up will be described in detail later.

Then, in a case where it is determined that the state is the state of the misalignment in abnormal lift-up, a stop control request signal is output, and the work stop is displayed on the display unit 302. Further, the stop control request signal is transmitted to the motor control unit 295, and a command is issued to stop the electric motor 215. The motor control unit 295 outputs a motor control signal in accordance with the received command and performs control to stop the electric motor 215.

Next, the winding-up mechanism 217 provided in the driver 210 will be described. As illustrated in FIG. 21A, the winding-up mechanism 217 includes the driver blade 229, a plurality of striking portion-side engagement portions provided on the driver blade 229, a pin wheel (rotating portion) 250, and a plurality of rotating portion-side engagement portions provided on the pin wheel 250. In a plane perpendicular to the center line All, the cross-sectional shape of the driver blade 229 is substantially quadrangular. The driver blade 229 is provided with racks 261, 262, 263, 264, 265, 266, 267, 268, 269, and 270 as a plurality of striking portion-side engagement portions. These racks 261, 262, 263, 264, 265, 266, 267, 268, 269, and 270 are provided integrally with the driver blade 229. Further, the racks 261, 262, 263, 264, 265, 266, 267, 268, 269, and 270 are disposed between the piston 228 and the tip 229a of the driver blade 229 in the direction along the center line All. In addition, the racks 261, 262, 263, 264, 265, 266, 267, 268, 269, and 270 are provided along the up-down direction M11, and are arranged in this order in the direction along the center line A11. In the driver 210 of the present second embodiment, the racks 261, 262, 263, 264, 265, 266, 267, 268, 269, and 70 are protrusions provided at the edge of the driver blade 229.

When the striking portion 212 operates in the return direction D12, the rack 261 among the plurality of racks is located at the head, that is, the first in the return direction D12. When the striking portion 212 operates in the return direction D12, the racks 262, 263, 264, 265, 266, 267, 268, 269, and 270 are located behind the rack 261.

Meanwhile, the pin wheel 250 is attached to the rotation shaft 246. The pin wheel 250 is a rotating portion that rotates by the driving force of the electric motor 215. For example, the pin wheel 250 is made of metal, non-ferrous metal, or steel. The pin wheel 250 rotates about the center line A12. The center line A12 is disposed apart from the driver blade 229 in the right-left direction R11 in a direction intersecting an operation direction of the striking portion 212.

The pin wheel 250 has a plurality of rotating portion-side engagement portions provided along the rotation direction E11. As an example of the plurality of rotating portion-side engagement portions, 10 pins 251, 252, 253, 254, 255, 256, 257, 258, 259, and 260 are provided at the pin wheel 250. The pins 251, 252, 253, 254, 255, 256, 257, 258, 259, and 260 is provided separately from the pin wheel 250, and is fixed to protrude from the disk surface of the pin wheel 250. Furthermore, the pins 251, 252, 253, 254, 255, 256, 257, 258, 259, and 260 are arranged on the same circumference about the center line A12.

In addition, in the pin wheel 250, a cutout portion 250a is formed in a second region at a predetermined angle in the rotation direction Ell of the pin wheel 250. The cutout portion 250a is formed in a region of 90° as an example. The minimum outer diameter of the cutout portion 250a centered on the center line A12 is smaller than the maximum outer diameter of a first region where the cutout portion 250a is not formed. The first region where the cutout portion 250a is not formed is a region of approximately 270° in the rotation direction E11 of the pin wheel 250.

Note that the pins 251, 252, 253, 254, 255, 256, 257, 258, 259, and 260 of the pin wheel 250 and the racks 261, 262, 263, 264, 265, 266, 267, 268, 269, and 270 of the driver blade 229 are provided at positions overlapping each other in the direction along the center line A12, and have a positional relationship of engaging with each other.

In addition, the pin wheel 250 rotates counterclockwise in FIG. 21A by the rotational force of the electric motor 215. In the pin wheel 250 of the present second embodiment, as an example, the pin 251 is disposed in the second region in the rotation direction E11 of the pin wheel 250, and the pins 252, 253, 254, 255, 256, 257, 258, 259, and 260 are disposed in the first region in the rotation direction E11 of the pin wheel 250. The pins 252, 253, 254, 255, 256, 257, 258, 259, and 260 are arranged in this order along the rotation direction E11 of the pin wheel 250. The pin 251 is located at the head, that is, at the first position in the rotation direction E11 during one rotation of the pin wheel 250.

In addition, the pins 252, 253, 254, 255, 256, 257, 258, 259, and 260 are located behind the pin 251 in the rotation direction E11 of the pin wheel 250. Therefore, when the pin wheel 250 rotates in a state where the striking portion 212 is stopped, the pin 251 of the plurality of pins first approaches an operational region of the driver blade 229 in the rotation direction E11 of the pin wheel 250.

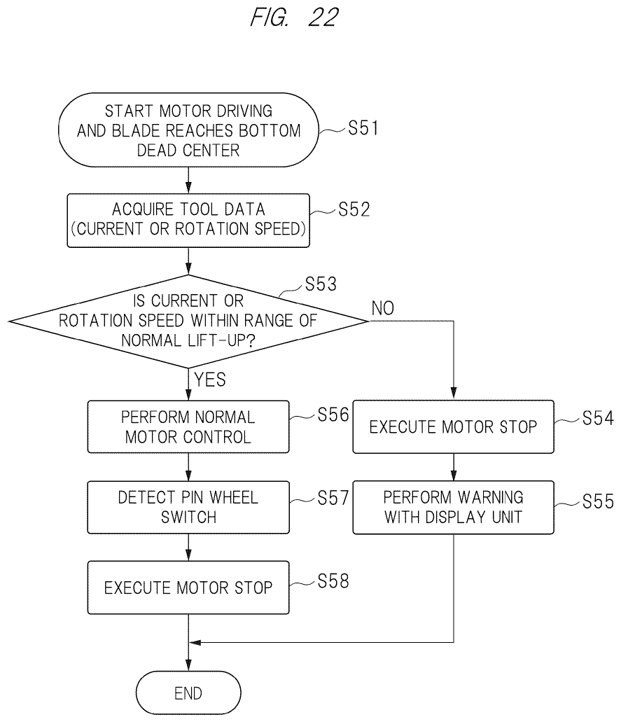

Next, a usage example of the driver 210 illustrated in FIG. 18 will be described with reference to a flowchart of FIG. 22. When at least one of a case where no operational force is applied to the trigger 275 and a case where the push lever 279 is not pressed against the driven material 230 is detected, the control unit 282 stops the supply of electric power to the electric motor 215. Therefore, the electric motor 215 is stopped, and the striking portion 212 is stopped at the standby position.

When detecting that the operational force is applied to the trigger 275 and that the push lever 279 is pressed against the driven material 230, the control unit 282 causes the power source unit 214 to apply a voltage to the electric motor 215 to rotate the electric motor 215 forward. As a result, the striking operation is started. The rotational force of the electric motor 215 is transmitted to the rotation shaft 246 via the speed reduction mechanism 216. Then, the rotation shaft 246 and the pin wheel 250 rotate counterclockwise in FIG. 21A, and the striking portion 212 rises. When the striking portion 212 rises, the gas pressure in the pressure chamber 226 illustrated in FIG. 18 rises. The speed reduction mechanism 216 makes the rotation speed of the pin wheel 250 lower than the rotation speed of the electric motor 215.

When the final pin 260 in the rotation direction E11 of the pin wheel 250 separates from the final rack 270, the striking portion 212 is lowered by the gas pressure of the pressure chamber 226. The position of the striking portion 212 at a time point when the pin 260 is separated from the rack 270 is the top dead center. When the striking portion 212 is lowered by the gas pressure of the pressure chamber 226, the driver blade 229 strikes one nail 278 located in the injection path 237, and the nail 278 is driven into the driven material 230.

After the nail 278 is driven into the driven material 230, the piston 228 collides with the bumper 235 (reaches the bottom dead center) (Step S51 in FIG. 22). The bumper 235 is elastically deformed by receiving a load in the direction along the center line A11 and absorbs a part of kinetic energy of the striking portion 212.

The control unit 282 continues the rotation of the electric motor 215 even after the striking portion 212 drives the nail 278 and reaches the bottom dead center. Therefore, the pin wheel 250 rotates counterclockwise as in FIG. 21A, and the pin 251 approaches the rack 261.

When the pin 251 is engaged with the rack 261, the striking portion 212 operates from the bottom dead center toward the standby position by the rotational force of the pin wheel 250. In addition, the pin 252 engages with and separates from the rack 262, and the pin 253 engages with and separates from the rack 263. As described above, since the pins of the pin wheel 250 and the racks of the driver blade 229 are sequentially engaged and separated, the driver blade 229 is wound up upward. When detecting that the striking portion 212 reaches the standby position, the control unit 282 stops the electric motor 215 and stops the rotation of the pin wheel 250.

Note that in the driver 210, as described above, when the pin wheel 250 rotates in the engagement state where any of the plurality of pins of the pin wheel 250 and any of the plurality of racks of the driver blade 229 is engaged with each other, the driver blade 229 moves upward (toward the other side) in the up-down direction M11. That is, the driver blade 229 is wound up in the return direction D12 by the rotation of the pin wheel 250 in the engagement state where the pin and the rack are engaged.

Furthermore, when the engagement state between the pin and the rack is released, the driver blade 229 moves downward (toward one side) in the up-down direction M11. That is, the driver blade 229 operates in the driving direction D11, thereby striking the nail 278.

In addition, the driver blade 229 moves upward (toward the other side) in the up-down direction M11 by re-engaging any of the plurality of pins and any of the plurality of racks into the engagement state since the pin wheel 250 rotates after the striking.

In the driver 210 of the present second embodiment, when the driver blade 229 moves upward in the up-down direction M11 after the striking, the control unit 282 determines whether the re-engagement is normal or abnormal based on the change in the rotation speed of the electric motor 215 or the change in the current value of the electric motor 215. At that time, the control unit 282 acquires tool data such as the current value or the rotation speed (Step S52), and then, determines whether or not the acquired data of the current value or the rotation speed is within the normal lift-up range (Step S53). In a case where it is determined that the re-engagement is abnormal (outside of the normal lift-up range), the control content of the electric motor 215 is changed. For example, in a case where it is determined that the re-engagement between any of the plurality of pins and any of the plurality of racks is abnormal, the electric motor 215 is stopped before the engagement state is released (Step S54). After the electric motor 215 is stopped, the display unit warning illustrated in Step S55 is executed.

On the other hand, in a case where it is determined in Step S53 that the acquired data of the current value or the rotation speed is within the normal lift-up range, the normal motor control in Step S56 is executed, and thereafter, the motor stop in Step S58 is executed by detecting the pin wheel switch (Step S57). That is, when detecting that the striking portion 212 has reached the standby position, the control unit 282 stops the electric motor 215 and stops the rotation of the pin wheel 250.

Here, in the driver 210, the pins 251, 252, 253, 254, 255, 256, 257, 258, 259, and 260 are provided at equal intervals in the rotation direction E11 of the pin wheel 250. On the other hand, the racks 261, 262, 263, 264, 265, 266, 267, 268, 269, and 270 of the driver blade 229 are provided at unequal intervals in an extension direction of the driver blade 229 (the direction along the up-down direction M11). Note that many of the misalignments between the pins and the racks occur between the first to third racks (racks 261 to 263) of the driver blade 229. Therefore, an unequal pitch portion is provided between one or more racks among the plurality of racks of the driver blade 229. Alternatively, an unequal pitch portion is provided between the first rack (rack 261) and the fourth rack (rack 264) of the driver blade 229.

As an example, as illustrated in FIG. 21B, the driver blade 229 includes a plurality of intermediate portions 271 provided between the plurality of racks, and any intermediate portion 271 of the plurality of intermediate portions 271 includes a deformation intermediate portion 271a having a different shape from the other intermediate portions 271b. For example, among the plurality of racks, a distance between the plurality of racks disposed with the deformation intermediate portion 271a interposed therebetween is different from a distance between the racks that are not disposed with the deformation intermediate portion 271a interposed therebetween. Specifically, a distance (pitch) P11 between the rack 262 and the rack 261 disposed on both sides of the deformation intermediate portion 271a with the deformation intermediate portion 271a interposed therebetween is longer than a distance (pitch) P12 between the rack 263 and the rack 262 that are not disposed with the deformation intermediate portion 271a interposed therebetween or a distance (pitch) P12 between the rack 263 and the rack 264 (P11 >P12). That is, the inter-rack pitches between the plurality of racks in the driver blade 229 are unequal. As an example, P11 is 11.25 mm, and P12 is 10.25 mm.

In addition, among the plurality of racks, two racks disposed on both sides of the deformation intermediate portion 271a have different shapes. For example, the rack 261 and the rack 262 disposed on both sides of the deformation intermediate portion 271a have different shapes. Specifically, a rack shape J11 of the rack 261 is different from a rack shape J12 of the rack 262, and the curvature of a concave curved surface 261b provided on the lower surface of the rack 261 is larger than the curvature of a concave curved surface 262b provided on the lower surface of the rack 262. The concave curved surface 261b is a part of the rack 261 and is also a part of the deformation intermediate portion 271a, and the concave curved surface 262b is a part of the rack 262 and is also a part of the other intermediate portion 271b. As described above, when the inter-rack pitch among the racks of the plurality of racks of the driver blade 229 and the shapes of the racks are made unequal, projections and recesses appear in a rotation speed waveform of the electric motor 215 or a current value waveform of the electric motor 215. This is because the resistance value changes in a portion where the inter-rack pitch is different among the plurality of racks as compared with other portions. Note that even if the shape of a top portion 261a of the rack 261 is made different from the shape of a top portion 262a of the rack 262 by providing an inclined surface at the top portion 261a of the rack 261, a change similarly appears in the rotation speed waveform of the electric motor 215 or the current value waveform of the electric motor 215.

Using this, in the driver 210, by setting a rack pitch longer or shorter than the inter-pin distance of the pin wheel 250 in the driver blade 229, the load at the time of lift-up (wind-up of the driver blade 229) is intentionally increased or decreased as compared with the case of an equal pitch. Then, the control unit 282 determines whether or not the lift-up is normally performed (whether or not the misalignment has occurred) from a change status of the rotation speed waveform of the electric motor 215 or the current value waveform of the electric motor 215 at the time of the lift-up.

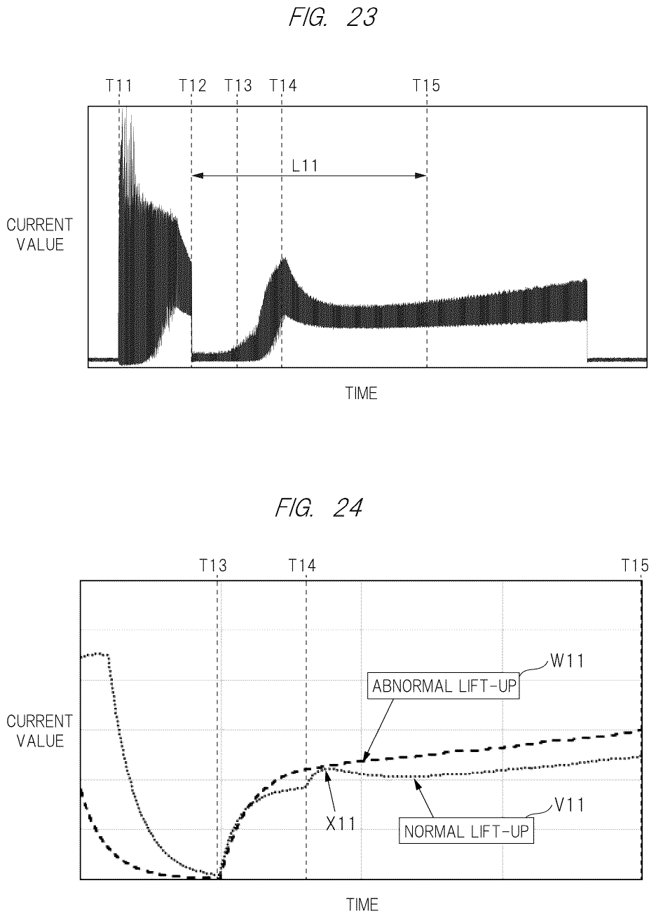

FIG. 23 illustrates the current value waveform of the electric motor 215 with respect to the elapsed time. Note that FIG. 23 is a schematic view in a case where the driver blade having an equal pitch is used without providing an unequal pitch portion as illustrated in FIG. 4 in the driver blade 229. When the trigger 275 and the push lever 279 are turned on, the motor is activated at the time T11, and subsequently the driver blade 229 reaches the bottom dead center at time T12. Note that the time T12 is also a point at which the engagement between the pin and the rack is released and the driver blade 229 is released. Thereafter, the pin wheel 250 is rotated by driving of the electric motor 215, and the lift-up of the driver blade 229 is started at the time T13 by the rotation of the pin wheel 250. A range before and after the start of the lift-up is set as a determination range L11, and it is determined whether or not the lift-up is normally executed (whether or not the misalignment has occurred). The time T15 is an end point of the determination.

Thus, the determination range L11 is a range from when the engagement between the pin and the rack is released and the driver blade 229 is released to when the re-engagement between the pin and the rack is executed and the driver blade 229 is moved upward in the up-down direction M11. The end point (time T15) of the determination in the determination range L11 is, for example, a time point immediately after the third pin (pin 253 in FIG. 21A) is engaged with the third rack (rack 263 in FIG. 21A), and as an example, a time point when 0.150 seconds have elapsed from the start of driving of the electric motor 215.

FIG. 24 illustrates current value waveforms of the normal lift-up V11 and the abnormal lift-up W11 in the determination range L11 in the engagement state with the pin wheel 250 illustrated in FIG. 21A by adopting the driver blade 229 with the unequal rack pitch illustrated in FIG. 21B. That is, the control unit 282 determines whether or not the misalignment between the pin and the rack has occurred due to a difference in current value waveform between the normal lift-up V11 and the abnormal lift-up W11 illustrated in FIG. 24. Specifically, the control unit 282 makes a determination in a range from when the engagement state between the pin and the rack is released to when the re-engagement between the pin and the rack is performed and the pin wheel 250 winds up the driver blade 229 upward in the up-down direction M11. That is, the determination is made in the determination range L11. At this time, when the current flowing through the electric motor 215 after the start of the lift-up gradually increases as in the current value waveform of the abnormal lift-up W11, the control unit 282 determines that the re-engagement is abnormal. This indicates a state where the first pin is engaged with, for example, the second rack (rack 262) or the third rack (rack 263) of the driver blade 229 illustrated in FIG. 21B. That is, this indicates a state where the first pin does not enter between the first rack and the second rack at the pitch P11 that are normal engagement but enters, for example, between the second rack and the third rack at the pitch P12 or between the third rack and the fourth rack (rack 264) at the pitch P12 due to misalignment. In this case, since the first pin does not enter between racks having unequal pitches, the current flowing through the electric motor 215 after the start of lift-up gradually increases as indicated by the abnormal lift-up W11. In this state, the control unit 282 determines that the re-engagement between the pin and the rack is abnormal.

On the other hand, as in the current value waveform of the normal lift-up V11, when the current flowing through the electric motor 215 after the start of the lift-up temporarily increases (projection X11), then decreases, and gradually increases again, this indicates a state where the first pin enters between the first rack and the second rack at the pitch P11 of the driver blade 229. In this case, since the pitch is different between the first rack and the second rack and between the second rack and the third rack, the resistance value temporarily changes, and the projection X11 indicated in the current value waveform of the normal lift-up V11 appears. In this state, the control unit 282 determines that the re-engagement between the pin and the rack is normal.

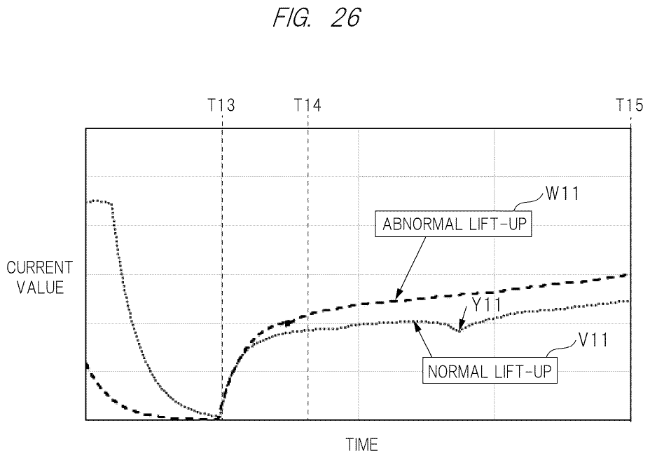

Note that even in a case where the current flowing through the electric motor 215 after the start of the lift-up is gradually increased after temporarily decreasing (recess Y11 in FIG. 26 which will be described later), it can be determined that the re-engagement is normal.

Note that as a more specific determination condition, the control unit 282 constantly detects the current change amount ΔI during the predetermined time Δt, and determines that the re-engagement between the pin and the rack is normal when ΔI/66 t<0 (the value of the current change amount ΔI during the predetermined time Δt is negative) is detected in a period between the time T13 and the time T15. On the other hand, when ΔI/Δt<0 (the value of the current change amount ΔI at the predetermined time Δt is negative) is not detected in the period between the time T13 and the time T15, the control unit 282 determines that the re-engagement is abnormal. However, this determination condition is merely an example, and the threshold value of ΔI/Δt may be any value other than 0. In addition, an absolute value of the current may be used instead of the amount of change in the current, and for example, in a case where the current value at the time T14 exceeds a predetermined threshold value, it may be determined as normal. In a case where a peak occurs in the waveform of the current, the peak generation time may be detected, and in a case where the peak generation time is a predetermined threshold or more, it may be determined as normal. Note that the estimation control using a neural network may be executed by acquiring the current value and the rotation speed in the time from the time T12 to the time T15, and executing machine learning of the current and the rotation speed waveform at the normal lift-up, and the current and the rotation speed waveform at the lift-up at the time of the misalignment.

When detecting the abnormality of the re-engagement between the pin and the rack, the control unit 282 performs control to stop the electric motor 215 before the engagement state between the pin and the rack is released. That is, the control unit 282 stops the electric motor 215 before the engagement state between the pin and the rack is released and the driver blade 229 is released.

As a result, even if the misalignment occurs in the engagement between the pin and the rack when the driver blade 229 is wound up, the control unit 282 stops the electric motor 215, so that the driver blade 229 is not released, and it is possible to prevent the pin from being damaged due to the collision between the driver blade 229 and the final pin (for example, pin 260) of the pin wheel 250. As a result, it is possible to improve the durability of the driver 210.

In addition, since it is possible to execute the misalignment determination without adding a component in the driver 210, it is possible to provide a product (working machine) at low cost.

Note that after detecting the abnormality of the re-engagement between the pin and the rack and stopping the electric motor 215, the control unit 282 may rotate the electric motor 215 in a direction opposite to the normal rotation direction in which the driver blade 229 is wound up. When the electric motor 215 is rotated in the reverse direction, the pin wheel 250 also rotates in the reverse direction to the normal rotation direction E11, and the driver blade 229 lowers to the bottom dead center with the rotation of the pin wheel 250. At this time, since the speed at which the driver blade 229 lowers is sufficiently lower than that at the time of normal driving, the rebound of the driver blade 229 is suppressed, and the stop position at the bottom dead center of the driver blade 229 is stabilized. When the operator applies the operational force to the trigger 275 while pressing the push lever 279 against the driven material 230 in a state where the electric motor 215 is stopped after the driver blade 229 reaches the bottom dead center and the pin 251 is detached from the rack, the control unit 282 rotates the electric motor 215 again in the normal rotation direction, and the pin 251 is engaged with the rack. At this time, since the pin 251 is engaged with the rack in a state where the driver blade 229 is stationary at the bottom dead center, the occurrence of misalignment is suppressed. When no abnormality is detected here, the normal striking operation may be executed (after the driver blade 229 rises to the top dead center beyond the standby position, the driver blade lowers to the bottom dead center while striking the nail 278, and stops the electric motor 215 when the driver blade rises to the standby position again), or the electric motor 215 may be stopped when the driver blade 229 rises to the standby position without executing the normal striking operation. Note that in a case where the control unit 282 detects an abnormality, the control may be performed such that the electric motor 215 is reversely rotated to cause the driver blade 229 to automatically perform the forward rotation after lowering to the bottom dead center, or the forward rotation and the reverse rotation may be repeatedly performed automatically until the abnormality is eliminated.

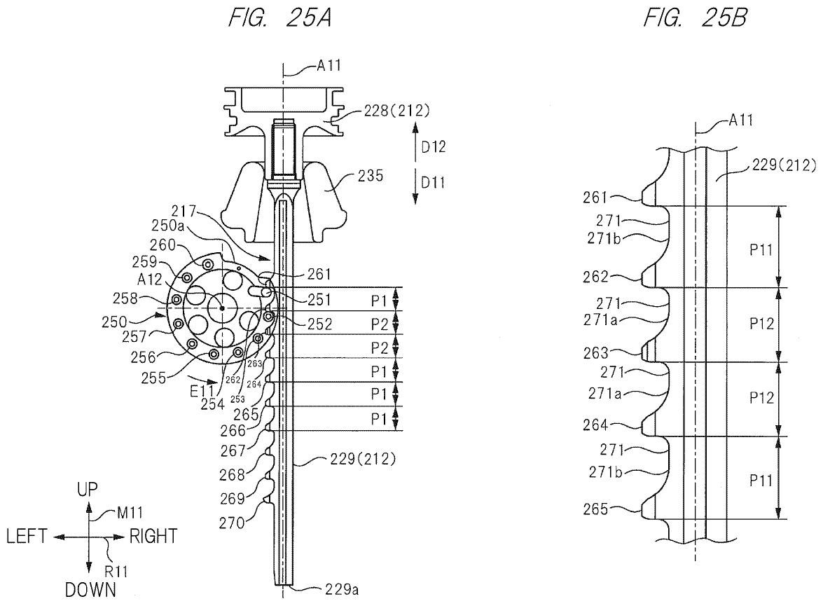

Next, a modification of the present second embodiment will be described. FIG. 25 is a diagram illustrating the modification example of the present second embodiment. In the modification example of FIGS. 25A and 25B, the installation positions of the racks having different pitches in the driver blade 229 are set to positions different from those of the driver blade 229 of FIG. 21B. That is, as illustrated in FIG. 25B, unequal pitch portions are provided between the first rack (rack 261) and the fourth rack (rack 264) of the driver blade 229 in the extension direction of the driver blade 229 (the direction along the up-down direction M11). Specifically, the distance (pitch) P12 between the rack 262 and the racks 261 disposed on both sides of the deformation intermediate portion 271a with the deformation intermediate portion 271a interposed therebetween and the distance (pitch P12) between the rack 264 and the racks 263 disposed on both sides of the deformation intermediate portion 271a with the deformation intermediate portion 271a interposed therebetween are shorter than the distance (pitch P11) between the racks that are not disposed with the deformation intermediate portion 271a interposed therebetween (P11>P12). That is, the inter-rack pitch of the plurality of racks in the driver blade 229 is set unequal similarly to the driver blade 229 illustrated in FIG. 21B. As an example, P11 is 10.25 mm, and P12 is 9.7 mm.

By setting the distance (pitch P12) between the rack 261 and the rack 262 and the distance (pitch P12) between the rack 263 and the rack 264 to be shorter than the distance (pitch P11) between the racks that are not disposed with the deformation intermediate portion 271a interposed therebetween, the control unit 282 determines the misalignment between the pin and the rack due to the difference in current value waveform between the normal lift-up V11 and the abnormal lift-up W11 illustrated in FIG. 26. FIG. 26 illustrates current value waveforms of the normal lift-up V11 and the abnormal lift-up W11 in the engagement state with the pin wheel 250 illustrated in FIG. 25A by adopting the driver blade 229 with the unequal rack pitch illustrated in FIG. 25B. That is, by setting the inter-rack pitch between the second rack (rack 262) and the fourth rack (rack 264) to an unequal pitch, the control unit 282 determines whether or not the misalignment has occurred due to the difference in current value waveform between the normal lift-up V11 and the abnormal lift-up W11 illustrated in FIG. 26. Specifically, in the determination range L11 of FIG. 23, in a case where the current flowing through the electric motor 215 after the start of the lift-up gradually increases as in the current value waveform of the abnormal lift-up W11 of FIG. 26, the control unit 282 determines that the re-engagement between the pin and the rack is abnormal. This indicates a state where the first pin is engaged with, for example, the third rack (rack 263) of the driver blade 229 illustrated in FIG. 25B. That is, this indicates a state where the first pin does not enter between the first rack and the second rack at the pitch P11 that are normal engagement but enters, for example, between the third rack and the fourth rack at the pitch P12 due to the misalignment. In this case, since all the inter-rack pitches after the fourth rack are the pitch P11, the current flowing through the electric motor 215 after the start of the lift-up of the driver blade 229 gradually increases as indicated by the abnormal lift-up W11. In this state, the control unit 282 determines that the re-engagement between the pin and the rack is abnormal.

On the other hand, as in the current value waveform of the normal lift-up V11, when the current flowing through the electric motor 215 after the start of the lift-up gradually increases, then temporarily decreases (recess Y11), and then gradually increases again, this indicates a state where the first pin enters between the first rack and the second rack at the pitch P11 of the driver blade 229. In this case, since the pitch is different between the first rack and the second rack and between the second rack and the third rack, the resistance value temporarily changes, and the recess Y11 indicated in the current value waveform of the normal lift-up V11 appears. In this state, the control unit 282 determines that the re-engagement between the pin and the rack is normal.

Even in the case of the modification example, when detecting the abnormality of the re-engagement between the pin and the rack, the control unit 282 performs control to stop the electric motor 215 before the engagement state between the pin and the rack is released. That is, the control unit 282 stops the electric motor 215 before the engagement state between the pin and the rack is released and the driver blade 229 is released. Specific determination conditions of the control unit 282 may be similar to those in the second embodiment.

As a result, even if the misalignment occurs in the engagement between the pin and the rack when the driver blade is wound up, the control unit 282 stops the electric motor 215, so that the driver blade 229 is not released, and it is possible to prevent the pin from being damaged due to the collision between the driver blade 229 and the final pin (for example, pin 260) of the pin wheel 250. As a result, also in the driver blade 229 of the modification example, it is possible to improve the durability of the driver 210.

### Third Embodiment

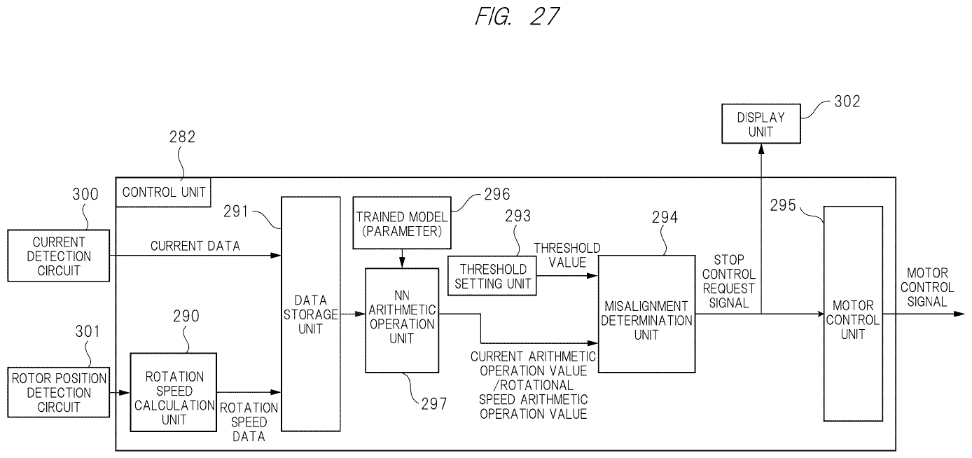

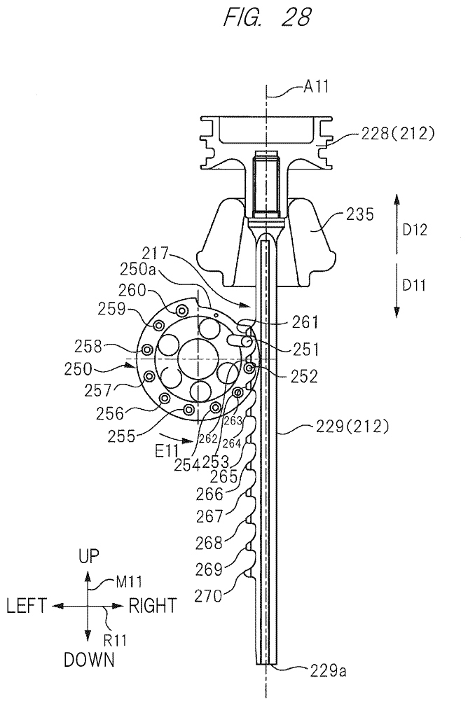

FIG. 27 is a block diagram of a control unit 282 of a working machine according to a third embodiment. In the present third embodiment, the change in the current value and the change in the rotation speed of the electric motor 215 due to the misalignment between the pin of the pin wheel 250 and the rack of the driver blade 229 are detected by artificial intelligence (AI). For example, the artificial intelligence is caused to perform machine learning of data of the current value and the rotation speed of the electric motor 215 in advance. The control unit 282 of the driver 210 detects the current value and the rotation speed of the electric motor 215 based on the data (learned model) obtained by the machine learning, and the detection value is compared with a result of the machine learning to determine whether or not there is the misalignment. As an example, in the present third embodiment, the control unit 282 executes estimation control of misalignment determination using a neural network (also referred to as an NN below). That is, in a state where the inter-pin pitch of the pin wheel 250 and the inter-rack pitch of the driver blade 229 are both set to be equal, the misalignment determination is performed by the artificial intelligence. FIG. 28 illustrates the driver blade 229 with an equal pitch between the racks. That is, in the driver blade 229 illustrated in FIG. 28, the racks are arranged such that all pitches between the racks are equal. Note that in the machine learning itself, data learned in the driver 210 in advance is stored in the control unit 282. Meanwhile, the learned model is data that is updated as needed by machine learning at the time of using the driver 210. Note that the control unit 282 in the present third embodiment has a configuration in which a current/rotational speed computing program 292 included in the control unit 282 illustrated in FIG. 20 is replaced with a trained model (learned model) 96 and an NN computing unit 297. The trained model 296 is data used for estimating a state of re-engagement between the pin and the rack based on the change in current value of the electric motor 215 or the change in rotation speed of the electric motor 215. In addition, the NN computing unit 297 is a computing circuit that controls the drive of the electric motor 215 in accordance with the re-engagement state between the pin and the rack, which is estimated by the trained model 296.

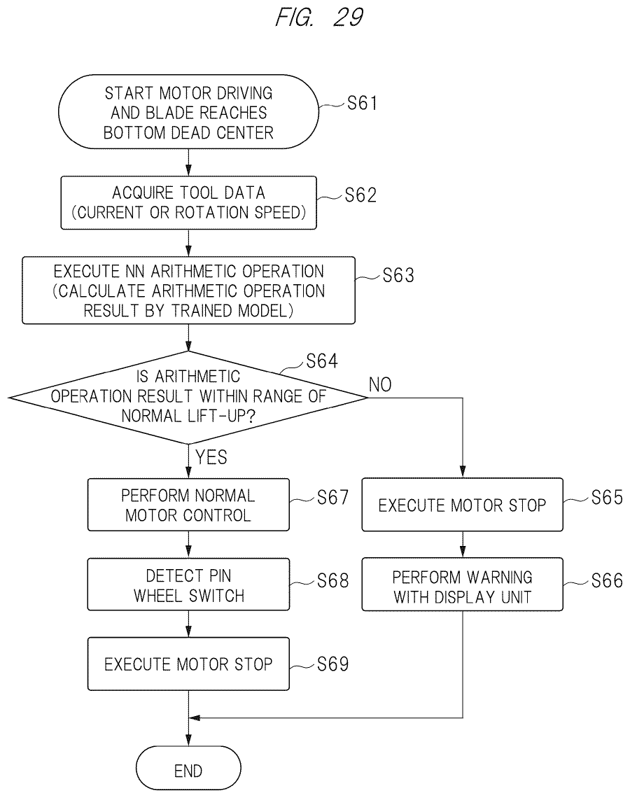

Here, the estimation control of the misalignment determination using the NN by the control unit 282 illustrated in FIG. 27 will be described with reference to the flowchart of FIG. 29. When detecting that the operational force is applied to the trigger 275 and that the push lever 279 is pressed against the driven material 230, the control unit 282 causes the power source unit 214 to apply a voltage to the electric motor 215 and to rotate the electric motor 215 forward. As a result, the striking operation is started. The rotational force of the electric motor 215 is transmitted to the rotation shaft 246 via the speed reduction mechanism 216. Then, the rotation shaft 246 and the pin wheel 250 rotate counterclockwise in FIG. 28, and the striking portion 212 rises. When the striking portion 212 rises, the gas pressure in the pressure chamber 226 illustrated in FIG. 18 rises. The speed reduction mechanism 216 makes the rotation speed of the pin wheel 250 lower than the rotation speed of the electric motor 215.

When the final pin 260 in the rotation direction E11 of the pin wheel 250 separates from the final rack 270, the striking portion 212 is lowered by the gas pressure of the pressure chamber 226. The position of the striking portion 212 at a time point when the pin 260 is separated from the rack 270 is the top dead center. When the striking portion 212 lowers to the bottom dead center point by the gas pressure of the pressure chamber 226, the driver blade 229 strikes one nail 278 located in the injection path 237, and the nail 278 is driven into the driven material 230 (Step S61 in FIG. 29).

Also in the driver 210 of the present third embodiment, when the driver blade 229 moves upward in the up-down direction M11 after striking, the control unit 282 determines whether the re-engagement is normal or abnormal based on the change in the rotation speed of the electric motor 215 or the change in the current value of the electric motor 215. At that time, the control unit 282 acquires tool data such as the current value or the rotation speed (Step S62), and then performs computing on the acquired data of the current value or the rotation speed by executing an NN computing, which will be described later, in Step S63. The control unit 282 determines whether or the computing result is within the normal lift-up range (Step S64). In a case where it is determined that the re-engagement is abnormal (outside of the normal lift-up range), the control content of the electric motor 215 is changed. For example, in a case where it is determined that the re-engagement between any of the plurality of pins and any of the plurality of racks is abnormal, the electric motor 215 is stopped before the engagement state is released (Step S65). After the electric motor 215 is stopped, the display unit warning illustrated in Step S66 is executed.

On the other hand, in a case where it is determined in Step S64 that the computing result calculated by the NN computing using the acquired current value or rotation speed data is within the normal lift-up range, the normal motor control in Step S67 is executed, and thereafter, the motor stop in Step S69 is executed by the detection of the pin wheel switch (Step S68). That is, when detecting that the striking portion 212 has reached the standby position, the control unit 282 stops the electric motor 215 and stops the rotation of the pin wheel 250.

Note that there is a difference in the current value and the rotation speed of the electric motor 215 between the normal lift-up and the abnormal lift-up at the time of misalignment. Therefore, in the estimation control of the misalignment, first, the current data and the rotation speed data are stored in the data storage unit 291 based on the signals transmitted from the current detection circuit 300 and the rotor position detection circuit 301. Then, when the stored data is input to the NN computing unit 297, the computing unit result that can be compared with the current computing value or the rotational speed computing value at the time of normal lift-up is calculated. At this time, as the parameters to be handled by the NN computing unit 297, the trained model 296 formed in advance by machine learning is used as the parameters. Then, the misalignment determination unit 294 determines whether there is a difference from the threshold value set by the threshold setting unit 293, that is, whether or not there is the misalignment. That is, the misalignment determination unit 294 determines whether the current data transmitted from the current detection circuit 300 and the rotation speed data transmitted from the rotor position detection circuit 301 are in a normal lift-up state or an abnormal lift-up misalignment state.

Then, in a case where it is determined that the state is the state of the misalignment in abnormal lift-up, a stop control request signal is output, and the work stop is displayed on the display unit 302. Further, the stop control request signal is transmitted to the motor control unit 295, and a command is issued to stop the electric motor 215. The motor control unit 295 outputs a motor control signal in accordance with the received command and performs control to stop the electric motor 215.

Here, the learned model formed by machine learning will be described. The learned model includes data generated based on the change in the current value of the electric motor 215 or the change in the rotation speed of the electric motor 215 while the pin of the pin wheel 250 and the rack of the driver blade 229 are disengaged from each other and then the pin and the rack are re-engaged to move the driver blade 229 upward in the up-down direction M11. Thus, the determination on the misalignment between the pin and the rack is performed in the determination range L11 (see FIG. 23) before and after the start of the lift-up of the driver blade 229 using the learned model.

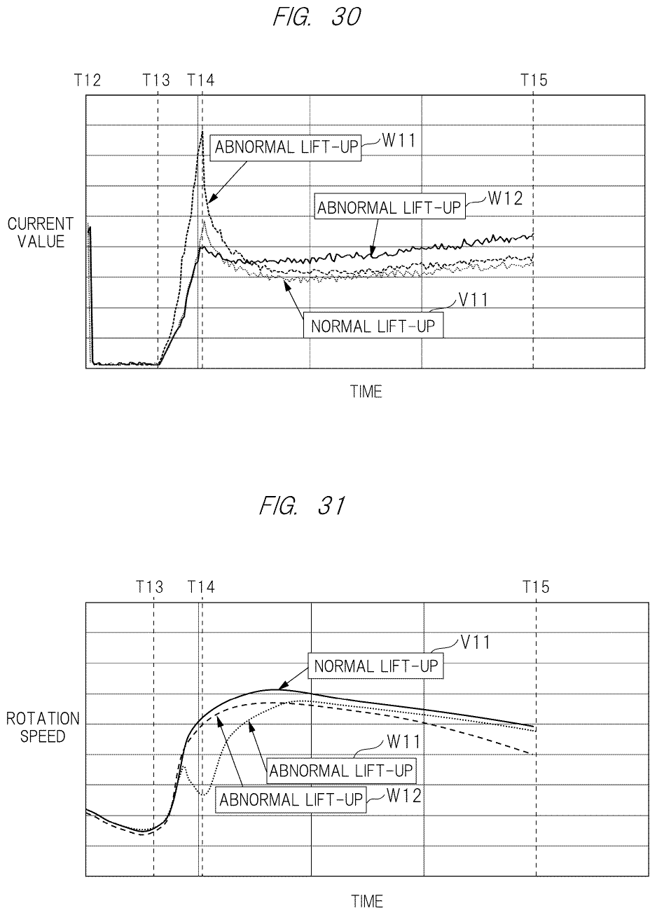

FIG. 30 illustrates current value waveforms of the electric motor 215 before and after the start of the lift-up of the driver blade 229 with respect to the elapsed time, and illustrates current value waveforms of the normal lift-up V11 and the abnormal lift-up W11. In the current value waveforms of the normal lift-up V11 and the abnormal lift-up W11, the current value increases immediately after the start of lift-up of the driver blade 229 at the time T13, becomes the maximum at the time T14, once decreases, and then gradually increases toward the time T15. On the other hand, in the abnormal lift-up W11, the peak of the current value at the time T14 is larger than the normal lift-up V11. In the abnormal lift-up W12, even if the current value at the time T14 is equal to or slightly lower than the normal lift-up V11, the current value at the time T15 becomes higher than the normal lift-up V11. As described above, the magnitude of the current value changes in accordance with the engagement state between the first pin (pin 251 in FIG. 28) and the first rack (rack 261 in FIG. 28) at the start of the lift-up, and are different between the normal lift-up V11 and the abnormal lift-up W11 and W12.

FIG. 31 illustrates the rotation speed waveform of the electric motor 215 before and after the start of the lift-up of the driver blade 229 with respect to the elapsed time, and illustrates the rotation speed waveform of each of the normal lift-up V11 and the abnormal lift-up W11. In both the normal lift-up V11 and the abnormal lift-up W11, the rotation speed reaches the peak value after the time T14, and then gradually decreases. On the other hand, in the current value waveform of the abnormal lift-up W11, the rotation speed decreases once at the time T14 immediately after the start of lift-up of the driver blade 229 at the time T13. This is a phenomenon caused by a slight shift in the engagement position between the first pin and the first rack at the start of lift-up, but this decrease is not observed in the normal lift-up V11, and the rotation speed continues to increase even at the time T14. In the abnormal lift-up W12, the rotation speed continues to increase even at the time T14, but the rotation speed at the time T15 becomes lower than the normal lift-up V11.

As described above, even in consideration of the variation that occurs every time the lift-up is performed, a slight difference occurs between the normal lift-up V11 and the abnormal lift-up W11 and W12 in the values of the current and the rotation speed at each time point and the shape of the waveform. It is possible to determine whether or not there is the misalignment by causing artificial intelligence to perform machine learning on these differences to obtain the learned model.

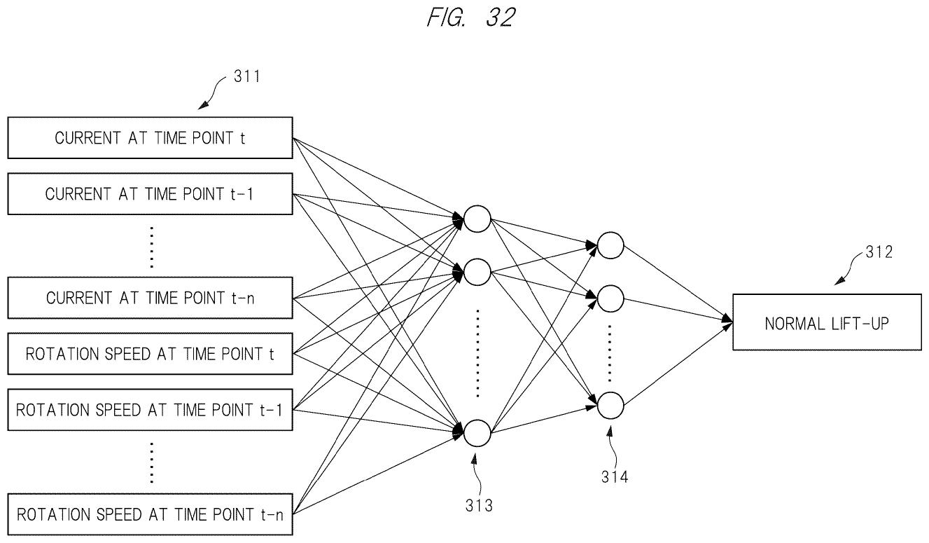

In addition, FIG. 32 is a diagram illustrating a structure of the neural network (NN) in normal lift-up. Since there is a difference in the current value and the rotation speed of the electric motor 215 between the normal lift-up and the abnormal lift-up at the time of the misalignment, using this, as illustrated in FIG. 32, a misalignment determination at the time of an abnormal lift-up is performed by an NN in which time series data of the current value and the rotation speed of a predetermined number of samples is used as input data 311 and detection of the normal lift-up is used as output data 312. In the misalignment determination of the present third embodiment, the machine learning and the actual computing are performed using the NN having the structure illustrated in FIG. 32. At this time, the data used for the machine learning is based on the data illustrated in FIG. 30 or FIG. 31. Here, the time series data of a predetermined width of the current value or the rotation speed is used. Time data immediately after driving the nail 278 and starting lift-up of the driver blade 229 from the bottom dead center is mainly used. In the estimation control using the NN illustrated in FIG. 32, as an example, a plurality of pieces of input data 311 is narrowed down to the primary narrowing data 313 by machine learning, and further narrowed down to the secondary narrowing data 314 to calculate the output data 312 of the normal lift-up. The narrowing down of the plurality of pieces of input data 311 by machine learning is executed by the influence of factors, the degree of relationship, and the like. That is, the output data 312 of the normal lift-up is finally calculated by removing the small influence by decreasing the coefficient as proceeding to the first order and the second order. Note that the number of times of narrowing down the plurality of pieces of input data 311 is not limited to 2, and may be 3 or more.

According to the estimation control using the NN of the present third embodiment, even if the misalignment occurs in the engagement between the pin and the rack when the driver blade is wound up, the control unit 282 stops the electric motor 215, so that the driver blade 229 is not released. Thus, it is possible to prevent the damage of the pin due to collision between the driver blade 229 and the final pin (for example, pin 260) of the pin wheel 250. As a result, it is possible to improve the durability of the driver 210. Note that, in the case of the air-compression type driver 210, the current value waveform and the rotation speed waveform of the electric motor 215 depend on the environmental temperature, the pressure in the pressure chamber, and the like, and the degree of difficulty in determining the misalignment by machine learning becomes high. However, since the current value waveform and the rotation speed waveform are intentionally changed between the normal time and the abnormal time in the determination of the misalignment of the present third embodiment, it is possible to easily perform the determination by the machine learning.

In addition, since it is possible to execute the misalignment determination without adding a component in the driver 210, it is possible to provide a product (working machine) at low cost.

The present invention is not limited to the above embodiments, and various modification examples can be made without departing from the gist of the present invention. For example, in the above first embodiment, the case where the rotation amount of the electric motor 15 is adopted as the cumulative information regarding the drive of the electric motor 15 when the rotation position of the pin wheel 50 is detected by the control unit 82 has been described. However, the cumulative value of the current flowing through the electric motor 15 may be adopted as the cumulative information. In addition, the drive time of the electric motor 15 may be adopted as the cumulative information. In addition, a detection target element such as a magnet may be provided in the pin wheel 50, a detection element such as a Hall sensor as a rotation position detection unit may be provided in the columnar portion 33, and the control unit 82 may directly detect the rotation position of the pin wheel 50 by detecting the position of the detection target element with the detection element. In the first embodiment described above, the striking portion-position detection unit includes the blade detector switch 80a that engages with the rib 29c of the driver blade 29. However, a configuration may be employed in which an element to be detected such as a magnet is provided in the driver blade 29, a detection element such as a Hall sensor as the striking portion-position detection unit is provided in the nose portion 13, and the position of the element to be detected is detected by the detection element, whereby the control unit 82 detects the position of the driver blade 29 in a non-contact state with the driver blade 29. The detection element may be a light emitting element and a light receiving element provided in the nose portion 13, and the element to be detected may be a through hole provided in the pin wheel 50 or the driver blade 29. In the first embodiment described above, whether or not the misalignment has occurred (whether or not the plurality of rotating portion-side engagement portions and the plurality of striking portion-side engagement portions have the predetermined engagement relationship) is detected while the driver blade 29 moves from the bottom dead center to the standby position toward the other (upper) side in the up-down direction M1. However, the configuration may be made in which the blade detector switch 80a is moved further upward to detect while the driver blade 29 moves from the standby position to the top dead center toward the other (upper) side in the up-down direction M1. In the second embodiment described above, the case where the inter-rack pitch of the driver blade 229 is set to the unequal pitch has been described. However, the inter-rack pitch of the driver blade 229 may be set to an equal pitch, and the inter-pin pitch of the pin wheel 250 may be set to an unequal pitch to perform the misalignment determination. It is also possible to configure a working machine including a plurality of the inventions described in the above first to third embodiments. For example, while the control unit detects the rotation position of the pin wheel and the position of the driver blade to determine whether the misalignment occurs based on the invention of the first embodiment, the determination of the misalignment using the current data and the rotation speed data may be performed based on the invention of the second embodiment, and/or the determination of the misalignment based on the machine learning may be performed based on the invention of the third embodiment. In addition, some of the configurations of the respective embodiments may be interchanged with each other. In this manner, it is possible to provide a working machine capable of more accurately determining the misalignment.

### EXPLANATION OF REFERENCE CHARACTERS

10 driver (working machine)
11 housing
12 striking portion
13 nose portion
14 power source unit
15 electric motor (motor)
17 winding-up mechanism
18 pressure accumulation container
19 cylinder case
20 handle
21 motor case
22 mounting portion
23 cap
24 holder
25 head cover
26 pressure chamber (biasing portion)
27 cylinder
28 piston
29 driver blade
29a distal end
29b blade body
29c rib
30 mating material
31 bumper support portion
33 columnar portion
35 bumper
36 guide hole
37 injection path
39 rotor
40 stator
46 rotation shaft
50 pin wheel (rotating portion)
50a cutout portion
51, 52, 53, 54, 55, 56, 57, 58, 59, 60 pin (rotating portion-side engagement portion)
61, 62, 63, 64, 65, 66, 67, 68, 69, 70 £ rack (striking portion-side engagement portion)
72 operation unit
75 trigger
76 accommodation case
77 magazine
78 nail (fastener)
79 push lever
80 striking portion-position detection unit
80a blade detector switch (first switch)
80b blade detector switch operation detection circuit
81 misalignment release switch (second switch)
81a misalignment release switch operation detection circuit
82 control unit
84 sealing member
100 current detection circuit
101 rotation position detection circuit
101a, 101b, 101c rotation position detection element (rotation position detection unit)
101d rotation speed detection circuit
102 power source switch
102a power source switch circuit
103
105 power source voltage supply circuit
106 voltage detection circuit
107 nail remaining-amount switch
107a nail remaining-amount switch operation detection circuit

108 push lever switch
108a push lever switch operation detection circuit
109 trigger switch
109a trigger switch operation detection circuit
110 inverter circuit
A1, A2 center line
D1 driving direction
D2 return direction
E1 rotation direction
M1 up-down direction (first direction)
N1 front-rear direction
Q1, Q2, Q3, Q4, Q5, Q6 switching element
R1 right-left direction
T1, T2, T3, T4, T5, T6, T7, T11, T12, T13, T14, T15, T16, T17,
T18, T19 time point
210 driver (working machine)
211 housing
212 striking portion
213 nose portion
214 power source unit
215 electric motor (motor)
216 speed reduction mechanism
217 winding-up mechanism
218 pressure accumulation container
219 cylinder case
220 handle
221 motor case
222 mounting portion
223 cap
225 head cover
226 pressure chamber (biasing portion)
227 cylinder
228 piston
229 driver blade
229a distal end
230 driven material
231 bumper support portion
232 injection portion
233 columnar portion
235 bumper
236 guide hole
237 injection path
239 rotor
240 stator
241 rotor shaft
242 bearing
243 gear case
244 power transmission shaft
245 bearing
246 rotation shaft
247 output element
248, 49 bearing
250 pin wheel (rotating portion)
250a cutout portion
251, 52, 53, 54, 55, 56, 57, 58, 59, 60 pin (rotating portion-side engagement portion)
261, 62, 63, 64, 65, 66, 67, 68, 69, 70 rack (striking portion-side engagement portion)
261a, 62a top portion
261b, 62b concave curved surface
271 intermediate portion
271a deformation intermediate portion
271b other intermediate portion
275 trigger
276 accommodation case
277 magazine
278 nail (fastener)
279 push lever
280 elastic member
281 fastener
282 control unit
283 motor board
284 sealing member
285 trigger sensor
290 rotation speed calculation unit
291 data storage unit
292 current/rotational speed computing program
293 threshold setting unit
294 misalignment determination unit
295 motor control unit
296 trained model
297 NN computing unit (computing unit)
300 current detection circuit
301 rotor position detection circuit
301a, 101b, 101c rotation position detection element
302 display unit
303 drive signal output circuit
304 battery voltage detection circuit
305 control power-source supply circuit
306 control power-source voltage detection circuit
307 pin wheel detection sensor
308 push lever switch
309 trigger switch
310 inverter circuit
311 input data
312 output data
314 secondary narrowing data
A11, A12 center line
D11 driving direction
D12 return direction
E11 rotation direction
J11, J12 rack shape
L11 determination range
M11 up-down direction (first direction)
N11 front-rear direction
P11, P12 pitch
Q11, Q12, Q13, Q14, Q15, Q16 switching element
R11 right-left direction
T11, T12, T13, T14, T15 time
V11 normal lift-up
W11 abnormal lift-up
X11 projection
Y11 recess

1. A working machine comprising:
a motor;
a striking portion capable of striking a fastener by moving to one side in a first direction;
a biasing portion that biases the striking portion to the one side in the first direction;
a rotating portion that rotates by a driving force of the motor and is engageable with and disengageable from the striking portion; and
a control unit that controls driving of the motor,
wherein the rotating portion includes a plurality of rotating portion-side engagement portions provided along a rotation direction of the rotating portion,
wherein the striking portion includes a plurality of striking portion-side engagement portions that is provided along the first direction and is engageable with the plurality of rotating portion-side engagement portions,
wherein the striking portion moves to another side in the first direction when the rotating portion rotates in a state where the plurality of striking portion-side engagement portions is engaged with the plurality of rotating portion-side engagement portions, and
when the engagement with the rotating portion is released, the striking portion executes a striking operation in which the striking portion moves to the one side in the first direction due to a biasing force of the biasing portion, thereby striking the fastener, and
wherein the control unit determines whether or not the plurality of striking portion-side engagement portions and the plurality of rotating portion-side engagement portions have a predetermined engagement relationship in the striking operation.

2. The working machine according to claim 1,
wherein the control unit is able to determine whether the striking operation is a first striking operation in which all of the plurality of rotating portion-side engagement portions is engaged with the plurality of striking portion-side engagement portions or a second striking operation in which some of the plurality of rotating portion-side engagement portions is not engaged with the plurality of striking portion-side engagement portions, and when the striking operation is the second striking operation, the control unit determines that the plurality of striking portion-side engagement portions and the plurality of rotating portion-side engagement portions do not have the predetermined engagement relationship.

3. The working machine according to claim 2, further comprising:
a rotation position detection unit that detects a rotation position that is a position of the rotating portion in the rotation direction; and
a striking portion-position detection unit that detects a striking portion-position that is a position of the striking portion in the first direction,
wherein the control unit determines whether the striking operation is the first striking operation or the second striking operation based on the rotation position and the striking portion-position.

4. The working machine according to claim 3,
wherein the control unit determines that the striking operation is the second striking operation in a case where the rotation position is outside of a predetermined range when the striking portion-position is a predetermined position.

5. The working machine according to claim 4,
wherein the striking portion-position detection unit includes a first switch that is turned on when the striking portion-position is located on the other side in the first direction with respect to the predetermined position.

6. The working machine according to claim 5,
wherein the first switch abuts on the striking portion when the striking portion-position is located on the other side in the first direction with respect to the predetermined position,
wherein the striking portion stops the striking operation when the striking portion reaches a standby position during execution of the striking operation, and
wherein the standby position in the striking operation is located on the other side in the first direction with respect to the predetermined position.

7. (canceled)

8. The working machine according to claim 3,
wherein the control unit has cumulative information regarding driving of the motor, which is accumulated while the motor is driven in the striking operation, and detects the rotation position based on the cumulative information, and
wherein the cumulative information is a rotation amount of the motor, a cumulative value of a current flowing through the motor or a driving time of the motor.

9. (canceled)

10. (canceled)

11. (canceled)

12. The working machine according to claim 2,
wherein the striking portion stops the striking operation when the striking portion reaches a standby position during execution of the striking operation, and
wherein the control unit determines whether the striking operation is the first striking operation or the second striking operation before the striking portion reaches the standby position in the striking operation.

13. The working machine according to claim 12,
wherein when the control unit determines that the striking operation is the second striking operation, the control unit reversely rotates the rotating portion until the striking portion reaches a bottom dead center position.

14. The working machine according to claim 13, further comprising:
a push lever capable of switching an operation of the motor to any of rotation of the motor and stop of the motor; and
a trigger capable of switching the operation of the motor to any of the rotation of the motor and the stop of the motor,
wherein a second switch is provided, the second switch being operated by an operator to start reverse rotation of the rotating portion in a state where the operator presses the push lever against a mating material and the operator operates the trigger to switch the operation of the motor to rotation.

15. The working machine according to claim 1,
wherein the control unit determines whether or not the striking portion-side engagement portions and the rotating portion-side engagement portions have a predetermined engagement relationship based on a change in rotation speed of the motor or a change in current value of the motor.

16. The working machine according to claim 15,
wherein the striking portion includes a plurality of intermediate portions provided between the plurality of striking portion-side engagement portions,
wherein any one of the plurality of intermediate portions includes a deformation intermediate portion having a shape different from a shape of another intermediate portion, and
wherein a distance between the plurality of striking portion-side engagement portions disposed with the deformation intermediate portion interposed therebetween among the plurality of striking portion-side engagement portions is different from a distance between the plurality of striking portion-side engagement portions that is not disposed with the deformation intermediate portion interposed therebetween.

17. (canceled)

18. The working machine according to claim 16,
wherein among the plurality of striking portion-side engagement portions, the plurality of striking portion-side engagement portions disposed with the deformation intermediate portion interposed therebetween have different shapes.

19. The working machine according to claim 16,
wherein the control unit determines that the striking portion-side engagement portion and the rotating portion-side engagement portion do not have the predetermined engagement relationship when a current flowing through the motor while the rotating portion moves the striking portion to the other side in the first direction gradually increases, and determines that the striking portion-side engagement portion and the rotating portion-side engagement portion have the predetermined engagement relationship when the current increases after temporarily decreasing or decreases after temporarily increasing.

20. The working machine according to claim 1,
wherein when the control unit determines that the plurality of striking portion-side engagement portions and the plurality of rotating portion-side engagement portions do not have the predetermined engagement relationship, the control unit stops the motor before the engagement is released with movement of the striking portion to the other side in the first direction.

21. (canceled)

22. (canceled)

23. A working machine comprising:
a motor;
a striking portion capable of striking a fastener by moving to one side in a first direction;
a biasing portion that biases the striking portion to the one side in the first direction;
a rotating portion that rotates by a driving force of the motor and is engageable with and disengageable from the striking portion; and
a control unit that controls driving of the motor,
wherein the rotating portion includes a plurality of rotating portion-side engagement portions provided along a rotation direction of the rotating portion,
wherein the striking portion includes a plurality of striking portion-side engagement portions that is provided along the first direction and is engageable with the plurality of rotating portion-side engagement portions,
wherein the striking portion moves to another side in the first direction when the rotating portion rotates in a state where the plurality of striking portion-side engagement portions is engaged with the plurality of rotating portion-side engagement portions, and
wherein when the engagement with the rotating portion is released, a striking operation in which the striking portion moves to the one side in the first direction due to a biasing force of the biasing portion, thereby striking the fastener is executed,
wherein the striking portion includes a plurality of intermediate portions provided between the plurality of striking portion-side engagement portions, and
wherein any of the plurality of intermediate portions includes a deformation intermediate portion having a shape different from a shape of another intermediate portion.

24. The working machine according to claim 23,
wherein a distance between the plurality of striking portion-side engagement portions disposed with the deformation intermediate portion interposed therebetween among the plurality of striking portion-side engagement portions is different from a distance between the plurality of striking portion-side engagement portions that is not disposed with the deformation intermediate portion interposed therebetween.

25. The working machine according to claim 24,
wherein among the plurality of striking portion-side engagement portions, the plurality of striking portion-side engagement portions disposed with the deformation intermediate portion interposed therebetween have different shapes.

26. A working machine comprising:
a motor;
a striking portion capable of striking a fastener by moving to one side in a first direction;
a biasing portion that biases the striking portion to the one side in the first direction;
a rotating portion that rotates by a driving force of the motor and is engageable with and disengageable from the striking portion; and
a control unit that controls driving of the motor,
wherein the rotating portion includes a plurality of rotating portion-side engagement portions provided along a rotation direction of the rotating portion,
wherein the striking portion includes a plurality of striking portion-side engagement portions that is provided along the first direction and is engageable with the plurality of rotating portion-side engagement portions,
wherein the striking portion moves to another side in the first direction when the rotating portion rotates in a state where the plurality of striking portion-side engagement portions is engaged with the plurality of rotating portion-side engagement portions, and
when the engagement with the rotating portion is released, a striking operation in which the striking portion moves to the one side in the first direction due to a biasing force of the biasing portion, thereby striking the fastener is executed, and
wherein the control unit includes a learned model that estimates a state of engagement between the plurality of striking portion-side engagement portions and the plurality of rotating portion-side engagement portions based on a change in current value of the motor or a change in rotation speed of the motor, and an computing unit that controls driving of the motor in accordance with the state of the engagement between the plurality of striking portion-side engagement portions and the plurality of rotating portion-side engagement portions, which is estimated by the learned model.

27. The working machine according to claim 26,
wherein the learned model includes data generated based on a change in current value of the motor or a change in rotation speed of the motor while the striking portion is moved to the other side in the first direction after the engagement between the plurality of rotating portion-side engagement portions and the plurality of striking portion-side engagement portions is released and the engagement is performed again.
